(19) United States
(12) Patent Application Publication
(10) Pub. No.: US 2026/0169233 A1
(43) Pub. Date: Jun. 18, 2026

(54) PANEL SYSTEM WITH MANAGED CONNECTIVITY

(71) Applicant: CommScope Technologies LLC, Claremont, NC (US)

(72) Inventors: Paul John PEPE, Clemmons, NC (US); Shawn Phillip TOBEY, Trinity, NC (US); Gary Federico GIBBS, Wylie, TX (US); John HIGGINS, Dallas, TX (US); Matthew Robert KIENER, McKinney, TX (US); Steven Walter KNOERNSCHILD, Allen, TX (US); Pedro MALDONADO, Dallas, TX (US)

(73) Assignee: CommScope Technologies LLC, Claremont, NC (US)

(21) Appl. No.: 19/122,838

(22) PCT Filed: Oct. 19, 2023
(86) PCT No.: PCT/US2023/077281

§ 371 Date: Apr. 21, 2025

Related U.S. Application Data
(60) Provisional application No. 63/380,462, filed on Oct. 21, 2022.
(60) Provisional application No. 63/380,515, filed on Oct. 21, 2022.
(60) Provisional application No. 63/450,871, filed on Mar. 8, 2023.
(60) Provisional application No. 63/489,102, filed on Mar. 8, 2023.

(51) Int. Cl. G02B 6/38; G02B 6/44

(52) U.S. Cl. CPC G02B 6/3849; G02B 6/3825; G02B 6/3881; G02B 6/4453

(57) ABSTRACT

A panel system includes a chassis holding one or more tray arrangements, which are each configured to receive one or more cassettes at two or more bays. The tray arrangements and cassettes cooperate to define a cassette sensor arrangement and a port occupancy sensor arrangement having separate interface points. The cassette sensor arrangement may include electronic memory storing physical layer information about the cassette. All active components of the port occupancy sensor arrangement are disposed on the tray while the electronic memories of the cassette sensor arrangement are stored on the cassettes.

### CROSS-REFERENCE TO RELATED APPLICATIONS

This application is being filed on Oct. 19, 2023, as a PCT International Application and claims the benefit of U.S. Provisional Application No. 63/380,462, filed Oct. 21, 2022; U.S. Provisional Application No. 63/380,515 filed Oct. 21, 2022; U.S. Provisional Application No. 63/450,871, filed Mar. 8, 2023; and U.S. Provisional Application No. 63/489,102, filed Mar. 8, 2023, the disclosures of which are hereby incorporated by reference in their entireties.

### BACKGROUND

Communications panel systems are used to interconnect various communication lines (e.g., telecommunications lines, data center lines, etc.) in one or more racking systems. In various cases, the panel system can support optical lines, electrical lines, and/or hybrid lines. Each panel system includes a plurality of front ports and a plurality of rear ports. In some implementations, equal numbers of front and rear cables are directly connected together at the front and rear ports. In other implementations, cassettes are provided at a panel system to communicatively connect one or more rear cables to a different number of front cables. As communications panel systems become more and more dense, accurately identifying which ports are available to support additional connections becomes more difficult.

Improvements are desired.

### SUMMARY

Some aspects of the disclosure are directed to a communications panel system including a tray adapted to receive one or more cassettes of various types in a variety of configurations. The cassettes capable of being received can vary in size, in the number of front ports, in the number of rear ports, and/or in the type of front and/or rear ports. In certain implementations, the tray holds a first portion of a cassette identification sensor arrangement. In certain implementations, the tray holds a first portion of a port occupancy sensor arrangement. In certain implementations, the tray holds both the first portion of the cassette identification sensor arrangement and the first portion of the port occupancy sensor arrangement.

In certain implementations, the first portion of the port occupancy sensor arrangement includes a magnetic sensor. In such implementations, the second portion of the port occupancy sensor arrangement includes a magnetic element (e.g., a magnet, a non-magnetic body having a magnetic coating, a non-magnetic body infused with magnetic particles, etc.). In certain examples, the magnetic sensor includes a Hall element. In certain examples, the magnetic element is carried by a port shutter of the cassette.

In certain implementations, the first portion of the port occupancy sensor arrangement includes a contact spring. In certain examples, the contact spring is disposed at an opposite side of the circuit board from the cassette. In certain examples, the contact spring includes an actuation surface the protrudes through the circuit board. Depression of the actuation surface results in breaking an electrical connection between the contact spring and a first contact interface location (e.g., a landing pad) of the circuit board.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an example tray arrangement holding two representative cassettes, the tray arrangement and cassettes being configured, in accordance with an embodiment of the disclosure.

FIG. 2 is a schematic diagram of an example cassette mounted at a tray arrangement so that a cassette identifier carried by the cassette engages or interfaces with a cassette sensor of the tray arrangement and an actuator of the cassette engages or interfaces with a plug sensor of the tray arrangement, in accordance with an embodiment of the disclosure.

FIG. 3 is a schematic diagram of an example panel system including a plurality of chassis holding a plurality of tray arrangements, each chassis having a communications unit by which signals from a cassette sensor arrangement and a port occupancy sensor arrangement can be provided to a remote server, in accordance with an embodiment of the disclosure.

FIG. 4 is a perspective view of a cross-section taken of an example cassette mounted to an example tray so that a first portion of a first example port occupancy sensor arrangement aligns with a second portion of the port occupancy sensor arrangement, in accordance with an embodiment of the disclosure.

FIG. 5 shows the second portion of the port occupancy sensor arrangement mounted to a shutter disposed in a closed position, in accordance with an embodiment of the disclosure.

FIG. 6 shows the shutter of FIG. 5 disposed in an open position and the second portion of the port occupancy sensor arrangement extending at least partially through a wall of the cassette towards a circuit board of the cassette, in accordance with an embodiment of the disclosure.

FIG. 7 is a perspective view of an example shutter including a first example mounting arrangement holding a magnetic element, in accordance with an embodiment of the disclosure.

FIG. 8 is a front elevational view of an example shutter including a second example mounting arrangement holding a magnetic element, in accordance with an embodiment of the disclosure.

FIG. 9 is a side elevational view of the shutter, magnetic element, and mounting arrangement of FIG. 8, in accordance with an embodiment of the disclosure.

FIG. 10 is a front elevational view of an example shutter including a third example mounting arrangement holding a magnetic element, in accordance with an embodiment of the disclosure.

FIG. 11 is a perspective view of an example shutter including the first example mounting arrangement of FIG. 7 disposed in a different orientation compared to FIG. 7, in accordance with an embodiment of the disclosure.

FIG. 12 is a perspective view of a cross-section taken of an example cassette having the shutters of FIG. 11, in accordance with an embodiment of the disclosure.

FIG. 13 is a perspective view depicting a first example adapter including a shutter arrangement configured in accordance with the principles of the disclosure.

FIG. 14 is a perspective view depicting a front of the first adapter of FIG. 13 with the shutter arrangement removed for ease in viewing an interior of the first adapter.

FIG. 15 is a perspective view of an example shutter arrangement suitable for use with the first adapter of FIG. 13.

FIG. 16 shows a hinge pin and door spring exploded outwardly from a door of the shutter arrangement of FIG. 15.

FIG. 17 is a top perspective view depicting a second example adapter defining multiple front ports and including the shutter arrangement of FIG. 15 at each port, the second adapter being configured in accordance with an embodiment of the disclosure.

FIG. 18 is a bottom perspective view of the second adapter of FIG. 17.

FIG. 19 is perspective view of an axial cross-section of the second adapter of FIG. 17.

FIG. 20 is a perspective view depicting a third example adapter including a shutter arrangement disposed at each front port configured in accordance with the principles of the disclosure.

FIG. 21 is a perspective view depicting the third adapter of FIG. 20 with the shutter arrangements removed for clarity.

FIG. 22 is a bottom perspective view of the third adapter of FIG. 20.

FIG. 23 is a perspective view of a portion of a shutter arrangement suitable for use with the third adapter of FIG. 20, where a hinge pin of the shutter arrangement is shown exploded from the shutter doors for ease in viewing.

FIG. 24 is a perspective view of an axial cross-section of the third adapter of FIG. 21.

FIG. 25 is another perspective view of the axial cross-section of the third adapter of FIG. 24.

FIG. 26 is a perspective view depicting a tray arrangement on which an example cassette is mounted in accordance with the principles of the disclosure, the cassette depicted as including the first, second, and third adapters disclosed herein.

FIG. 27 is an exploded, perspective view of the tray arrangement of FIG. 26.

FIG. 28 is an enlarged view of a portion of FIG. 26 in which the cassette is visible.

FIG. 29 is a perspective view of a cross-section taken of an example cassette mounted to an example tray so that a first portion of a first example port occupancy sensor arrangement aligns with a second portion of the port occupancy sensor arrangement, in accordance with an embodiment of the disclosure.

FIG. 30 is an enlarged view of a portion of the managed tray of FIG. 29 with portions removed for ease in viewing actuation surfaces of the first portion of the port occupancy sensor arrangement, in accordance with an embodiment of the disclosure.

FIG. 31 is a perspective view of an example contact spring suitable for use as part of the first portion of the port occupancy sensor arrangement, in accordance with an embodiment of the disclosure.

FIG. 32 is a side elevational view of the contact spring of FIG. 31, in accordance with an embodiment of the disclosure.

FIG. 33 is a perspective view of a first example type of shutter including an actuator extending from an interior surface of the shutter, in accordance with an embodiment of the disclosure.

FIG. 34 is a perspective view of a second example type of shutter including an actuator extending from an interior surface of the shutter, in accordance with an embodiment of the disclosure.

FIG. 35 is a perspective view of a cross-section taken of an example cassette mounted to an example tray so that a first portion of a second example port occupancy sensor arrangement aligns with a second portion of the port occupancy sensor arrangement, in accordance with an embodiment of the disclosure.

FIG. 36 is a perspective view of a portion of an example managed tray at which an actuation surface of the first portion of a second example port occupancy sensor arrangement protrudes through the circuit board, in accordance with an embodiment of the disclosure.

FIG. 37 is a perspective view of an example contact spring suitable for use as part of the first portion of the port occupancy sensor arrangement, in accordance with an embodiment of the disclosure.

FIG. 38 is a side elevational view of the contact spring of FIG. 37, in accordance with an embodiment of the disclosure.

FIG. 39 is a perspective view depicting the first example adapter of FIG. 13 including a shutter arrangement configured in accordance with the principles of the disclosure.

FIG. 40 is a perspective view depicting a front of the first adapter of FIG. 39 with the shutter arrangement removed for ease in viewing an interior of the first adapter.

FIG. 41 is a perspective view of an example shutter arrangement suitable for use with the first adapter of FIG. 39.

FIG. 42 shows a hinge pin and door spring exploded outwardly from a door of the example shutter arrangement of FIG. 41.

FIG. 43 is a top perspective view depicting the second example adapter of FIG. 17 defining multiple front ports and including the shutter arrangement of FIG. 41 at each port, the second adapter being configured in accordance with an embodiment of the disclosure.

FIG. 44 is a bottom perspective view of the second adapter of FIG. 43.

FIG. 45 is perspective view of an axial cross-section of the second adapter of FIG. 43.

FIG. 46 is a perspective view depicting the third example adapter of FIG. 20 including another example shutter arrangement disposed at each front port configured in accordance with the principles of the disclosure.

FIG. 47 is a perspective view depicting the third adapter of FIG. 46 with the shutter arrangements removed for clarity.

FIG. 48 is a bottom perspective view of the third adapter of FIG. 46.

FIG. 49 is a perspective view of a portion of a shutter arrangement suitable for use with the third adapter of FIG. 46, where a hinge pin of the shutter arrangement is shown exploded from the shutter doors for ease in viewing.

FIG. 50 is a perspective view of an axial cross-section of the third adapter of FIG. 46.

FIG. 51 is another perspective view of the axial cross-section of the third adapter of FIG. 50.

FIG. 52 is a schematic view of a cross-section of an example port member having a shutter carrying a magnetic element and a noncontact (e.g., Hall effect) sensor disposed to sense the magnetic element when the shutter door is shut and to not sense the magnetic element when the shutter door is open.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

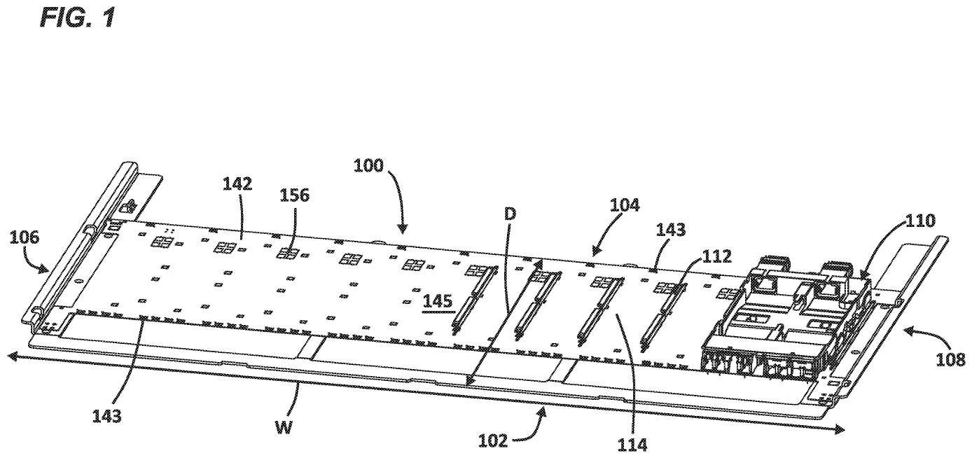

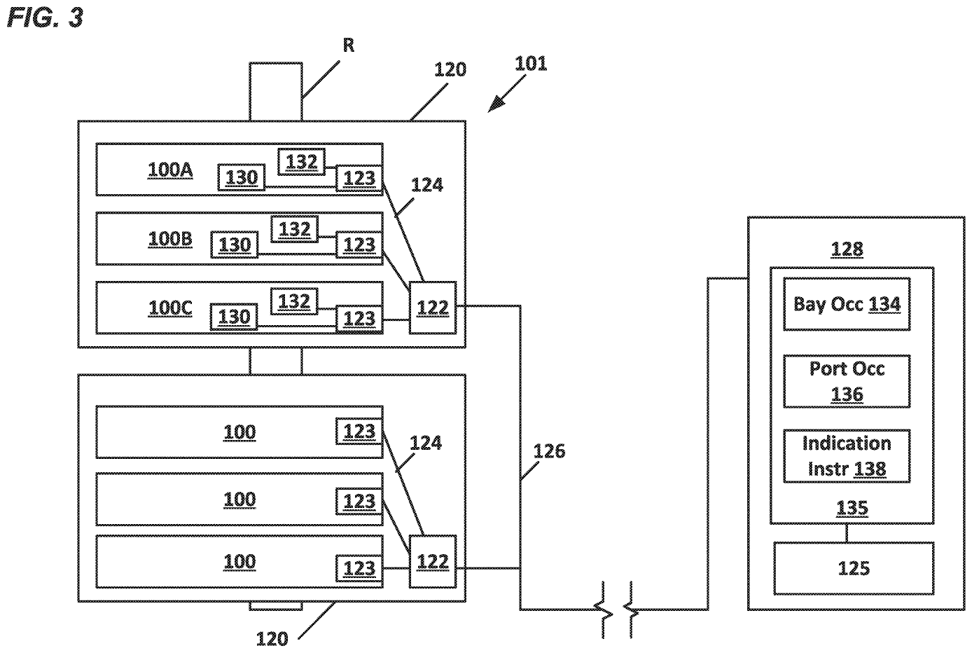

The present disclosure is directed to a tray arrangement 100 (FIG. 1) for use in a panel system (e.g., see panel system 101 of FIG. 3). The tray arrangement 100 is mountable (e.g., fixedly mountable, slidably mountable, etc.) within a chassis 120 of the panel system 101. As shown in FIG. 1, the tray arrangement 100 extends along a depth D between a front 102 and a rear 104 and extends along a width W between opposite first and second sides 106, 108. The tray arrangement 100 is configured to receive one or more cassettes 110 carrying port members 116 and/or other communications equipment (e.g., optical splice holders, optical power splitters, wave division multiplexers, active components, power amplifiers, etc.). One or more cassettes 110 may be mounted to the tray arrangement 100. Each cassette 110 carries one or more port members 116 that each define one or more front ports configured to receive an adapter, which in turn can be configured to receive a plug. Certain types of port members 116 also define one or more rear ports configured to receive an adapter, which in turn can be configured to receive a plug. Certain types of cassettes 110 carry one or more port members 116 that define at least front ports and one or more port members that define at least rear ports.

In certain implementations, the tray arrangement 100 is a managed tray arrangement configured to monitor occupancy and/or availability of the front ports. The tray arrangement 100 includes at least a first portion of a port occupancy sensor arrangement. When a plug connector is received at the front port of a cassette 110 mounted to the tray arrangement 100, the port occupancy sensor arrangement generates a signal indicating the front port is occupied. In certain implementations, the cassette 110 includes a second portion of the port occupancy sensor arrangement that cooperates with the first portion to generate the signal. In certain examples, the second portion of the port occupancy sensor arrangement is actuated via movement of a dust shutter disposed at the front port.

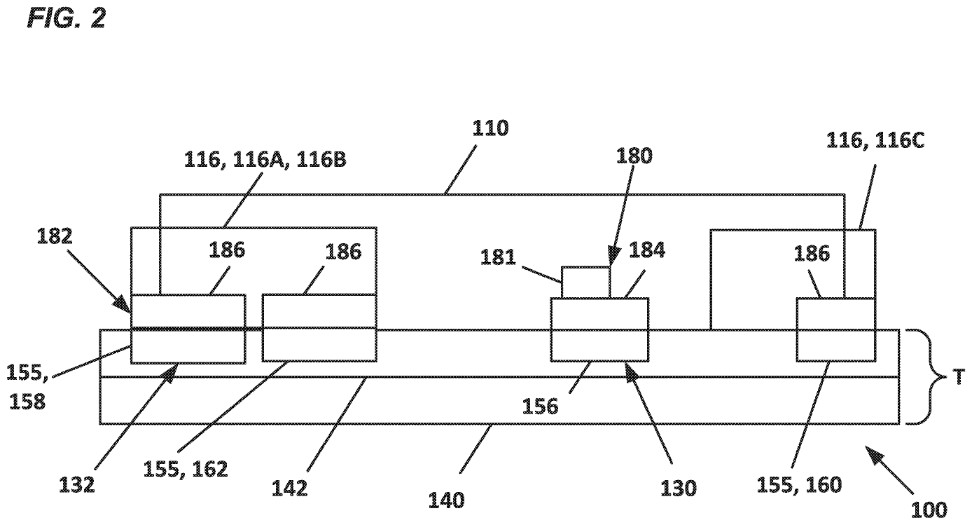

FIG. 2 schematically illustrates an example cassette 110 mounted to an example tray arrangement 100 with a port occupancy sensor arrangement. In the example shown, the tray arrangement 100 includes a circuit board 142 mounted to a tray base 140. The tray arrangement 100 includes the first portion 132 of the port occupancy sensor arrangement. In certain examples, the first portion 132 is disposed at the circuit board 142. The cassette 110 includes the second portion 182 of the port occupancy sensor arrangement. Engagement or other interaction between the first and second portions 132, 182 of the port occupancy sensor arrangement triggers a determination that a plug connector has been received at a port.

In certain implementations, the tray arrangement 100 also includes a first portion 130 of a cassette sensor arrangement and the cassette 110 includes a second portion 180 of the cassette sensor arrangement. Engagement or other interaction between the first and second portions 130, 180 of the cassette sensor arrangement triggers a determination that a cassette 110 has been mounted at the tray arrangement 100 (e.g., at one or more bays of the tray arrangement 100). In certain examples, the determination that the cassette 110 has been mounted at the tray arrangement 100 triggers a reading of physical layer information carried by the cassette 110.

FIG. 3 shows an example panel system 101 configured to receive signals (e.g., raw analog signals or processed digital signals) from the first portion 132 of the port occupancy sensor arrangement and to aggregate and/or analyze the signals. In some examples, the communications units 122 are directly electrically connected to the first portion 132 of the port occupancy sensor arrangement. In other examples, the communications units 122 are electrically connected to the first portions 132 of the port occupancy sensor arrangement via intermediate components (e.g., integrated circuits) disposed on the circuit board 142. The panel system 101 also includes a remote server or servers 128 that receives signals from the communication unit(s) 122 as will be discussed in greater detail herein.

In certain implementations, the panel system 101 also is configured to receive signals (e.g., raw analog signals or processed digital signals) from the first portions 130 of the cassette sensor arrangement. In some examples, the communications units 122 are directly electrically connected to the first portion 130 of the cassette sensor arrangement. In other examples, the communications units 122 are electrically connected to the first portions 130 of the port occupancy sensor arrangement via intermediate components (e.g., integrated circuits) disposed on the circuit board 142.

In FIG. 3, the example panel system 101 includes two representative chassis 120 mounted to a rack R. In other examples, a greater or lesser number of chassis 120 may be mounted to the rack R and the panel system 101 may include a greater number of racks. In the example shown, each chassis 120 receives three tray arrangements 100A, 100B, 100C. In other examples, a chassis 120 may receive a greater or lesser number of tray arrangements 100 (e.g., one, two, four, five, six, eight, twelve, etc.). Each tray arrangement 100 carries at least one first portion 130 of a cassette sensor arrangement to detect a cassette on the tray arrangement 100 and/or at least one first portion 132 of a port occupancy sensor arrangement to detect port occupancy on the tray arrangement 100. In certain examples, the first portion 130 also reads information (e.g., physical layer information) from any cassette mounted at the respective port.

Each tray arrangement 100 also carries a tray connector 123 (e.g., a PCBA-to-cable connector) that receives the signals from the cassette occupancy sensor arrangement and/or the port occupancy sensor arrangement of the tray arrangement 100. In certain examples, the tray connector 123 is configured to provide an interface between a circuit board 142 and a cable. The tray connector 123 is connected to the cassette occupancy sensor arrangement and/or the port occupancy sensor arrangement by tracings on the circuit board 142 of the tray arrangement 100. In certain examples, the tray connector 123 is mounted at the rear 104 of the tray arrangement 100.

In certain implementations, each chassis 120 includes a respective communications unit 122 that receives (e.g., via cable 124) and optionally aggregates the data signals from the connector 123. In certain examples, the communications unit 122 services all of the tray arrangements 100 (i.e., the cassette sensor arrangements and port occupancy sensor arrangements of the tray arrangements 100) within the chassis 120. In other examples, a communications unit 122 may service tray arrangements 100 from multiple chassis 120. In still other examples, multiple communications units 122 may services the tray arrangements 100 of one chassis 120. Each communications unit 122 communicates with the remote server 128 via a connection 126 (e.g., a cabled connection, a wireless connection, etc.).

The remote server(s) 128 includes a processor 125 and memory (e.g., non-volatile memory) 135. In memory 135, the remote server 128 stores port occupancy data 136 so that the port availability of each tray arrangement 100 can be determined at the remote location. In certain examples, the memory 135 may also store cassette data 134 to determine bay occupancy. In certain examples, the remote server 128 also may store instructions 138 in memory for indicating a bay or port at one of the tray arrangements 100 (e.g., using an LED or other indicator) as will be described in more detail herein. The memory 135 also may store instructions for determining which bays are occupied based on information read from the electronic memory 181 of each cassette 110. In certain implementations, the remote server 128 can be implemented on a standalone compute server. In certain implementations, the remote server 128 can be implemented in a rack-level management device in an Automated Infrastructure Management (AIM) system.

Referring back to FIG. 1, in certain implementations, the tray arrangement 100 includes a plurality of cassette guides 112 extending in parallel along the depth D of the tray arrangement 100. The cassette guides 112 are spaced along the width W to define a plurality of bays 114 at which the cassettes 110 can be mounted. In certain implementations, each cassette 110 spans at least two bays 114. In various examples, each cassette 110 may span two, three, four, five, six, or more bays 114. In other implementations, a cassette 110 may span a single bay 114.

A first type of example cassette 110 may hold a first row of port members 116 defining front ports and rear ports at which first connectorized media segments and second connectorized media segments are aligned and connected. In some examples, the first type of cassette 110 holds a plurality of single-fiber port members (e.g., LC ports, SC ports, etc.) 116A. In other examples, the first type of example cassette 110 may hold a plurality of multi-fiber port members (e.g., MPO ports, SN ports, etc.) 116B. A second type of example cassette 110 may hold a first row of ports members 116, 116A, 116B and one or more rear port members 116C defining rear ports at which a connectorized media segment can be received. Circuitry (e.g., optical circuitry, electrical circuitry, etc.) within the cassette 110 connects the rear port member(s) 116C to the rear ports of the front port members 116, 116A, 116B so to connect the connectorized media segments received at the front ports to the connectorized media segment(s) received at the rear port(s). Other types of cassettes 110 are possible (e.g., cassettes carrying splice holders, optical splitters, power amplifiers, etc.).

In accordance with certain aspects of the disclosure, the tray arrangement 100 is configured to enable monitoring of port occupancy and availability at each cassette 110 mounted to the tray arrangement 100. For example, the tray arrangement 100 may enable monitoring of the occupancy of the front ports of the row of port members 116A, 116B. In certain examples, the tray arrangement 100 may enable monitoring of the occupancy of the rear ports of rear port members 116C. In certain examples, the tray arrangement 100 may enable monitoring of the occupancy of the rear ports of the front port members 116A, 116B. Port occupancy can be tracked and aggregated at the remote location (e.g., a remote server or network of servers) 128.

In accordance with certain aspects of the disclosure, the tray arrangement 100 is configured to enable monitoring of bay occupancy and availability at the tray arrangement 100. In certain examples, bay occupancy can be tracked and aggregated at the remote location (e.g., a remote server or network of servers) 128.

Referring to FIGS. 1 and 2, in certain implementations, the first portion 132 of the port occupancy sensor arrangement includes one or more plug sensors 155 disposed in each of the bays 114. In certain examples, each plug sensor 155 is positioned to align with a respective port carried by a cassette 110 when the cassette 110 is mounted to the tray arrangement 100. Each cassette 110 carries one or more actuators 186 forming the second portion 182 of the port occupancy sensor arrangement. Each actuator 186 is positioned to align with a respective plug sensor 155 when the cassette 110 is mounted to the tray arrangement 100. Each actuator 186 is configured to not automatically engage or otherwise interface with the respective plug sensor 155 when the cassette 110 is mounted to the tray arrangement 100. Rather, each actuator 186 is configured to engage or otherwise interface with the respective plug sensor 155 when a plug connector is received at the corresponding port. In certain implementations, the actuators 186 are passive components and the cassette 110 does not carry any active components of the port occupancy sensor arrangement.

In certain implementations, the first portion 132 of the port occupancy sensor arrangement includes a sufficient number of plug sensors 155 in each bay 114 to accommodate the smallest port type carried by a cassette 110. For example, each bay 114 may carry sufficient plug sensors 155 to sense occupancy for each of a plurality of LC ports carried by a cassette 110. However, as noted above, different types of cassettes 110 may carry different numbers and types of ports. Accordingly, in such implementations, multiple plug sensors 155 may align with one port of the cassette 110. In some such implementations, each actuator 186 may be configured to engage or otherwise interface with each plug sensor 155 aligned with the respective port. In other implementations, the cassette 110 may carry multiple actuators 186 for each port carried by the cassette 110. In still other implementations, the electronic memory 181 of the cassette 110 stores the type (and hence size) of the ports. In such implementations, the communications unit 122 and/or remote server 128 may use the stored information to determine port occupancy even if fewer than all plug sensors 155 across a port are actuated. In other implementations, a plug sensor 155 is provided for each larger-sized port (e.g., MPO ports) with the understanding that smaller sized ports (e.g., LC ports) function as duplex ports that span the distance of the larger-sized ports.

In some implementations, each cassette 110 carries a respective actuator 186 for each port carried by the cassette 110. In other implementations, each cassette 110 carries a respective actuator 186 for each externally-facing port carried by the cassette 110. For example, the cassette 110 may carry an actuator 186 for each front port of the front port members 116A, 116B. In some examples, the cassette 110 carries an actuator for each of the front ports 116. In other examples, the cassette 110 carries an actuator 186 for half of the front ports (e.g., for each duplex front port). In some examples, the cassette 110 carries an actuator 186 for each rear port of each rear port member 116C of the cassette 110. In other examples, the cassette 110 carries an actuator 186 for the rear ports of the front port members 116A, 116B. In still other examples, the cassette 110 also carries an actuator 186 for the internally-facing ports (e.g., rear ports of the front port members and front ports of the rear port members). In the example shown in FIG. 2, the cassette 110 carries actuators 186 for the front ports of first port members 116, for the rear ports of the front port members 116, and for the rear ports of the rear port member 116C.

In accordance with certain aspects of the disclosure, the tray arrangement 100 is configured to enable reading of physical layer information from any cassette 110 mounted thereto. Examples of such physical layer information includes the type of cassette 110 (e.g., an optical termination cassette carrying adapters configured to connect first and second cables, an optical splice cassette configured to carry one or more optical splices, a conversion module configured to receive different types of connectors at the front and rear of the cassette, etc.), the size of the cassette 110 (e.g., the number of bays 114 the cassettes spans), the number and type of port members 116 carried by the cassette 110 (e.g., duplex LC adapters, SC adapters, MPO adapters, SN adapters, MDC adapters, single-pair sockets, etc.), fiber routing for conversion/module cassettes, media segment type (e.g., fiber, electrical, hybrid, etc.) and other such information.

In certain implementations, a respective cassette sensor 156 of the first portion 130 of the cassette sensor arrangement is disposed in each of at least some of the bays 114. Each cassette 110 carries a respective cassette identifier 184, which forms the second portion 180 of the cassette sensor arrangement. The cassette identifier 184 is configured to automatically engage or interface with the cassette sensor 156 when the cassette 110 is mounted at the bay 114 as will be discussed in more detail herein. As noted above, in certain examples each cassette 110 spans two or more of the bays 114. In some implementations, each cassette 110 carries a cassette identifier 184 for each bay 114 the cassette 110 spans. However, in certain implementations, each cassette 110 carries only one cassette identifier 184, which engages or otherwise interacts with the cassette sensor 156 in only one of the bays 114 being spanned.

In such implementations, the cassette identifier 184 includes an electronic memory 181 that stores information (e.g., physical layer information) about the cassette 110 and an interface by which the stored information can be passed as will be described in more detail herein. In an example, the electronic memory 181 form part of an I²C circuit. In certain examples, the information stored in electronic memory 181 on the cassette 110 includes the type of cassette 110, the size of the cassette 110 (e.g., the number of bays 114 that cassettes spans), the number and type of port members 116 carried by the cassette 110, internal fiber routing within the cassette, the media segment types, and other such information.

The cassette sensor 156 is configured to read (or enable reading by a respective communications unit 122) of the electronic memory 181 to obtain the stored information. In certain such examples, the cassette identifier 184 is disposed in a common location relative to a cassette latching arrangement on each cassette 110. Accordingly, the number of bays 114 spanned by the cassette 110 can be determined (e.g. by the communications unit 122 or by the remote server(s) 128) and hence the specific bays occupied by the cassette 110 can be identified. Example cassette latching arrangements suitable for use on the cassettes 110 are disclosed in U.S. Provisional Appl. No. 63/150,840, filed Feb. 18, 2021, titled “Cassette Latching Arrangement,” [having attorney docket number 02316.8226USP1], the disclosure of which is hereby incorporated herein by reference in its entirety.

For example, the cassette 110A of FIG. 1 spans two bays 114. Accordingly, the electronic memory 181 of the cassette 110A would store the information that the cassette 110A spans two bays 114. If the cassette identifier 184 of the cassette 110A were mounted at the left side of the cassette 110A in FIG. 1, then the cassette identifier 184 would engage the cassette sensor 156 of the left-most bay 114. Further, the cassette sensor 156 of the left-most bay 114 would read (or allow to be read) the number of bays the cassette spans from the electronic memory 181 of the cassette 110A via the cassette identifier 184. From this information, it could be determined (e.g., by the communications unit 122 and/or the remote server(s) 128) that the cassette 110A spans the left-most bay 114 and the adjacent bay 114. Accordingly, the occupancy of both bays 114 would be known.

In certain implementations, fewer than each of the bays 114 has a corresponding cassette sensor 156. For example, if all cassettes 110 have the cassette identifier 184 disposed at a right side of the cassette 110 and if all cassettes 110 span at least two bays 114, then the left-most bay 114 would never align with the cassette identifier 184 of a cassette 110. Accordingly, the cassette sensor 156 could be omitted from the left-most bay 114 in such an implementation. Similarly, if the cassette identifier 184 were always disposed at the left side of the cassette 110, then the cassette sensor 156 could be omitted from the right-most bay 114.

In certain implementations, cassette sensors 156 are disposed in at least one set of adjacent bays 114 even when all cassettes 110 span at least two bays 114. While cassettes 110 span at least two bays 114, some cassettes 110 may span more than two bays 114 (e.g., three bays, four bays, six bays, etc.). Disposing cassette sensors 156 in adjacent bays provides flexibility for mounting cassettes 110 of various sizes to a common tray arrangement 100. For example, referring back to FIG. 1, a second cassette 110B mounted adjacent the first cassette 110A spans two bays 114. Because the first cassette 110A spans the first two bays 114 from the left side of the tray arrangement 100, the second cassette 110B spans the third and fourth bays 114 from the left side of the tray arrangement 100. If the cassette identifiers 184 of the cassettes 110 are disposed at left sides of the cassettes 110, then the cassette identifier 184 of the second cassette 110A engages or otherwise interacts with the cassette sensor 156 in the third bay 114 from the left side of the tray arrangement 100. However, if the first cassette 110A had spanned three bays instead of two bays (i.e., had spanned the first three bays from the left side of the tray arrangement), then the second cassette 110B would have occupied the fourth and fifth bays 114. In such a case, the cassette identifier 184 of the second cassette 110B would have engaged or otherwise interacted with the cassette sensor 156 of the fourth bay 114. Accordingly, disposing cassette sensors 156 in adjacent bays 114 (e.g., in both the third bay and the fourth bay) enables sensing and determining cassette positions even when the sizes of the cassettes 110 can vary.

In certain implementations, the communications unit 122 and/or the remote server 128 use the information obtained from the cassette identifier 184 to determine which plug sensors 155 of the port occupancy sensor arrangement to read. The cassette identifier 184 includes information on the number and type of the port members carried by the cassette 110. From this information, the position of the port members 116 can be determined. The communications unit 122 and/or the remote server 128 may then ignore information obtained by plug sensors 155 not properly aligned with the port members 116. For example, a cassette 110 carrying MPO type port members 116 in the front will not activate (i.e., ignore) half of the forward plug sensors 155 within the respective bay(s) 114 because those plug sensors 155 would align with and hence only be used with LC type port members 116. Similarly, rear port members 116 may be present or not present on the cassette 110. The physical layer information read from the cassette identifier 184 informs the communications unit 122 and/or the remote server 128 whether to read or ignore signals from the rear plug sensors 155.

Additional information about the panel system including the communications unit 122 and/or the remote server 128 can be found in PCT Appl. No. PCT/US2022/026171, filed Apr. 25, 2022, and titled “Panel System with Managed Connectivity,” the disclosure of which is hereby incorporated herein by reference in its entirety.

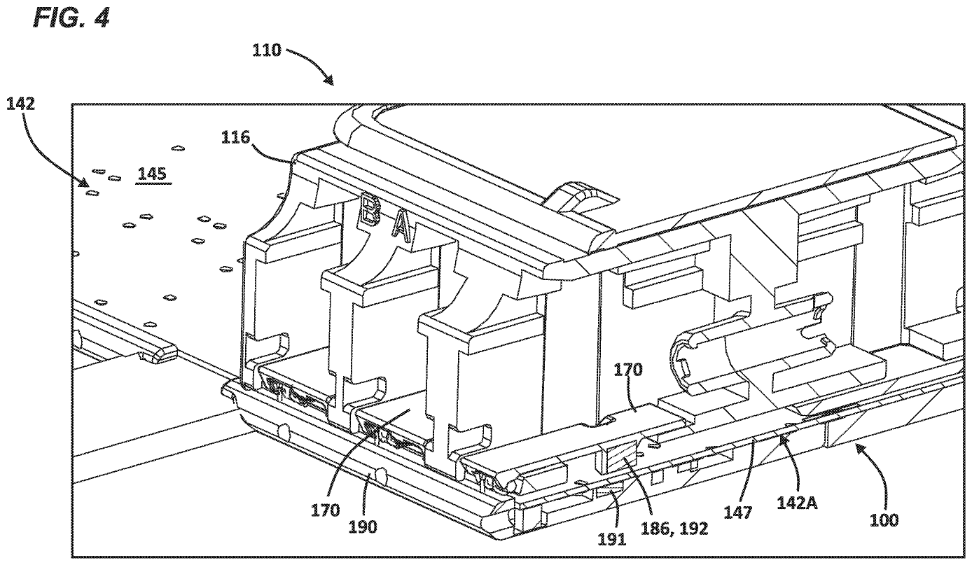

FIGS. 4-6 illustrate first and second portions 132, 182 of an example port occupancy sensor arrangement suitable for use with the tray arrangement 100 and cassettes 110 of FIGS. 1-3. In certain implementations, the first portion 132 of the port occupancy sensor arrangement includes a non-contact sensor 191 mounted to the circuit board 142. Accordingly, the cassette 110 moves relative to the non-contact sensor 191 as the cassette 110 is mounted to the tray arrangement 100. In certain implementations, the non-contact sensor 191 is mounted to an opposite side of the circuit board 142 from the cassette 110. In some implementations, the non-contact sensor 191 is a magnetic sensor. In certain implementations, the magnetic sensor 191 is configured to detect changes in a magnetism generated by a changes in a position of a magnet. In an example, the magnetic sensor 191 includes a Hall element. In other examples, however, other types of magnetic sensors 191 are possible.

In certain implementations, the circuit board 142 extends forwardly past the front of the tray 110 so that a portion 142A of the circuit board 142 is disposed forward of the tray 110. In certain examples, the magnetic sensor 191 is mounted to the portion 142A of the circuit board 142. In certain implementations, a bezel 190 is mounted to the circuit board 142 to cover the portion 142A. In certain examples, the bezel 190 covers the magnetic sensor 191.

The circuit board 142 has a first major side 145 and a second major side 147. In certain implementations, when the circuit board 142 is mounted to the tray 110, the second major side 147 of the circuit board 142 faces the tray 110 and the first major side 145 faces away from the tray 110. In certain examples, the cassette 110 is disposed at the first major side 145 and the sensor 191 is disposed at the second major side 147 of the portion 142A of the circuit board 142 so that the circuit board 142 is disposed between the cassette 110 and the sensor 191.

In certain implementations, the second portion 182 of the port occupancy sensor arrangement includes an actuator 186 carried by a shutter door 170 of a port of the cassette 110. In certain examples, the actuator 186 includes a magnetic element 192. In some examples, the magnetic element 192 includes a magnet (e.g., a button magnet). In other examples, the magnetic element 192 includes a non-magnetic (e.g., plastic) body having a magnetic coating (e.g., magnetic paint). In still other examples, the magnetic element 192 includes a non-magnetic body infused with magnetic particles. The shutter door 170 is configured to move (e.g., pivot or deflect) between a closed position and an open position. In certain examples, the shutter 170 is biased to the closed position. In certain examples, the shutter 170 is biased closed by a torsion spring 129 having a first end engaging the interior surface 173 of the shutter body 172 and a second end engaging the cassette 110.

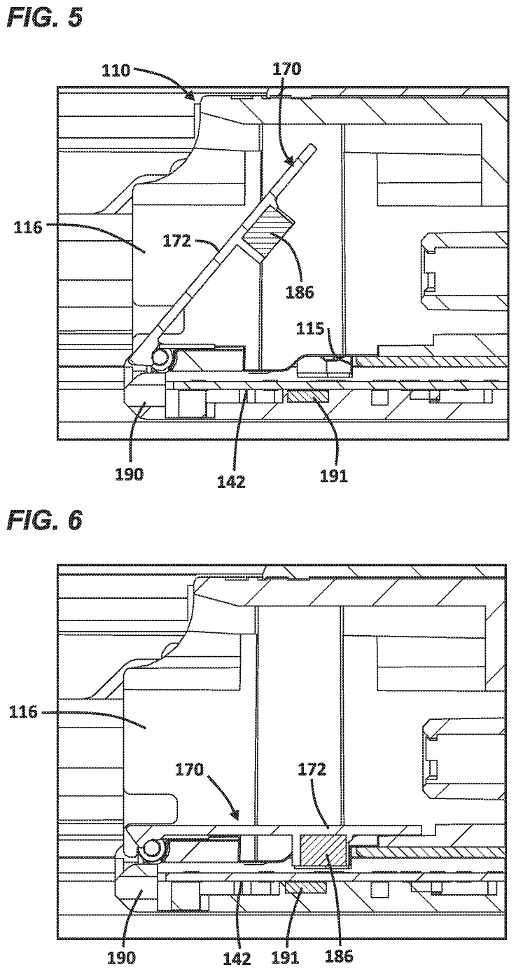

When in the closed position (e.g., see FIG. 5), the shutter door 170 extends across and blocks access to a respective front port from an exterior of the cassette 110. When in the open position (e.g., see FIG. 6), the shutter door 170 allows access to the front port from the exterior of the cassette 110. When the shutter 170 is disposed in the closed position, the magnetic element 192 is sufficiently spaced from the magnetic sensor 191 to not trigger the sensor 191. When the shutter 170 is disposed in the open position, the magnetic element 192 is sufficiently close to the magnetic sensor 191 to trigger the sensor 191 to generate the occupancy signal. In other implementations, however, the magnetic sensor 191 may be positioned to be triggered by the magnetic element 192 when the shutter door is closed and so that opening the shutter 170 moves the magnetic element 192 out of range with the magnetic sensor 191.

Referring now to FIGS. 5 and 6, in certain implementations, the cassette 110 includes a body defining an aperture 115 aligned with the sensor 191 on the circuit board 142. When the shutter 170 is moved to the open position, the actuator 186 protrudes through the aperture 115 of the cassette 110 towards the circuit board 142. In some examples, the actuator 186 contacts the first side 145 of the circuit board 142 when the shutter 170 is disposed in the open position. In other examples, the actuator 186 is spaced from the first side 145 of the circuit board 142 when the shutter 170 is disposed in the open position.

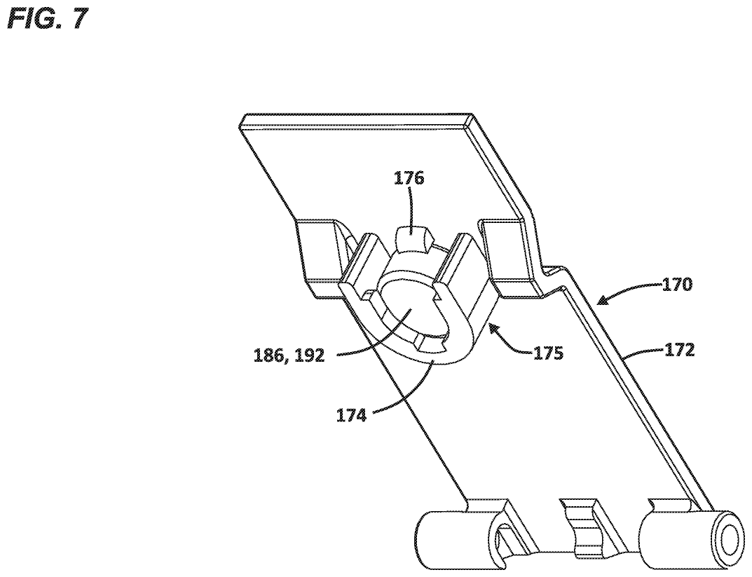

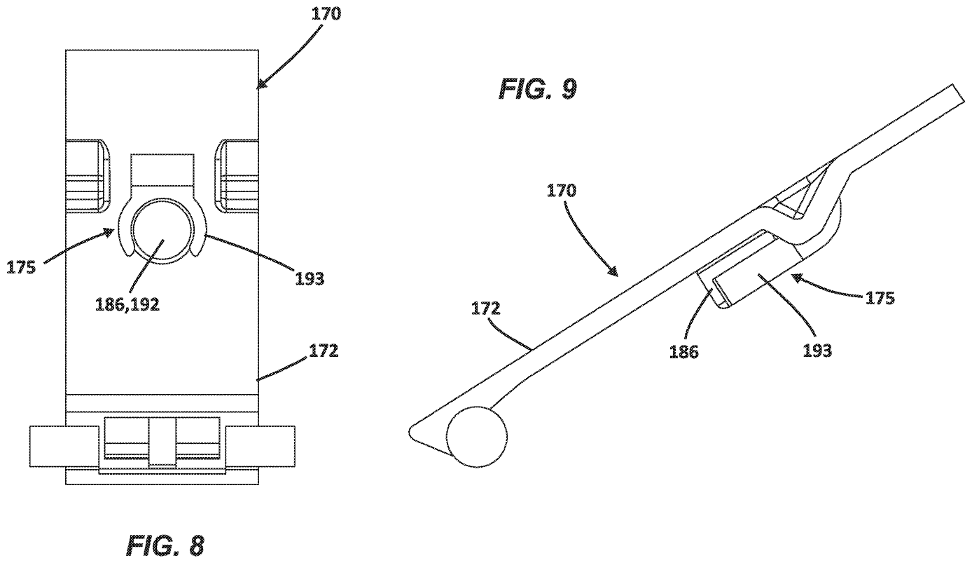

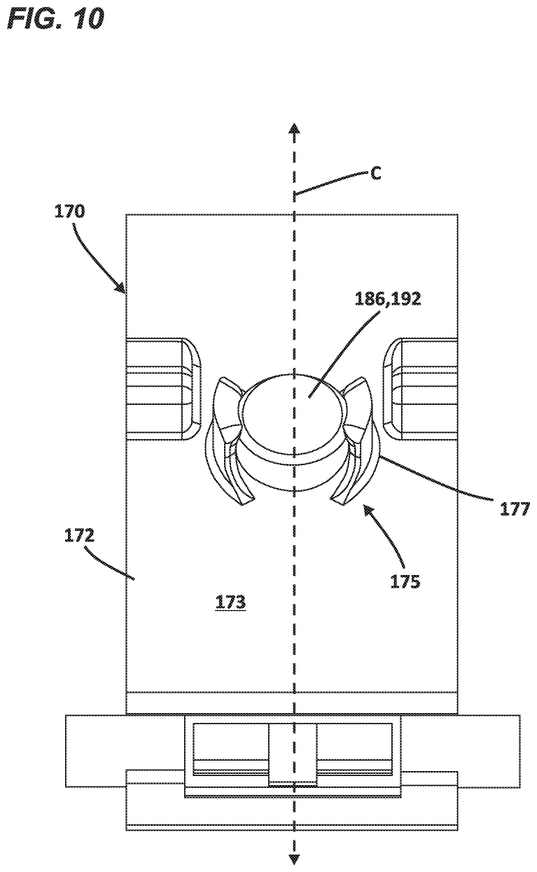

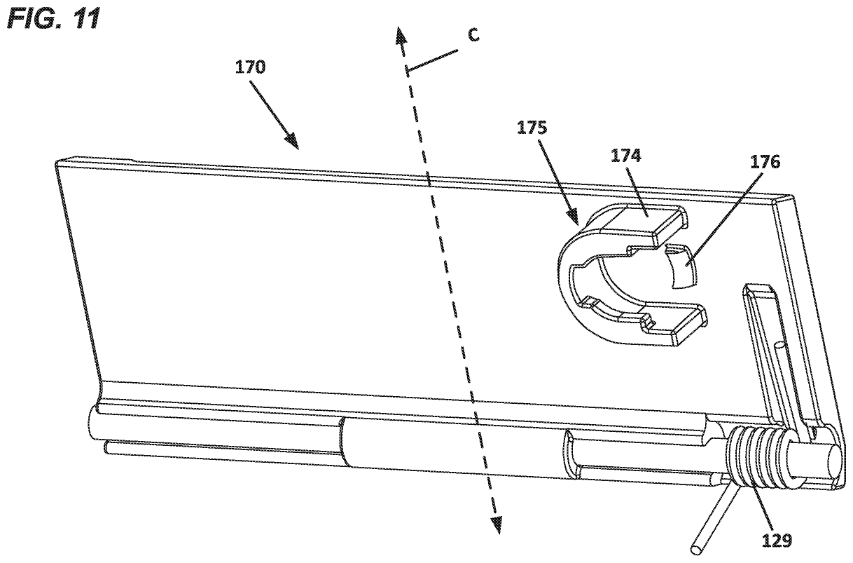

FIGS. 7-11 illustrate various example implementations of mounting arrangements 175 suitable for mounting the magnetic element 192 to a body 172 of a shutter 170. In certain examples, the mounting arrangement 175 is monolithically formed with the shutter body 172. FIG. 7 shows a first example mounting arrangement 175 including a cradle 174 and stop tab 176. FIGS. 8 and 9 show a second example mounting arrangement 175 including a snap-fit receiver 193. FIG. 10 shows a third example mounting arrangement 175 including latch arms 177 extending outwardly from an interior surface of the shutter 170. FIG. 11 shows the first example mounting arrangement 175 disposed on a shutter 170 having a different shape of body 172.

As shown in FIG. 7, the cradle 174 defines a pocket in which the magnetic element 192 can be slid. For example, the magnetic element 192 can be slid along the body 172 of the shutter 170 and into the pocket. The stop tab 176 defines an inwardly facing shoulder and an outwardly facing ramp. The shoulder faces the pocket. The ramp faces away from the pocket. The ramp allows the magnetic element 192 to be slid into the pocket over the stop tab 176. The shoulder engages the magnetic element 192 to hold the magnetic element 192 in the pocket.

As shown in FIGS. 8 and 9, the snap-fit receiver 193 includes two contoured arms extending partially around an annular periphery to define a receiving space. Distal ends of the arms are spaced apart by a gap that is smaller than a cross-dimension (e.g., diameter) of the magnetic element 192. As the magnetic element 192 is slid into the receiving space through the gap, the arms deflect or flex outwardly to allow passage of the magnetic element 192. When the magnetic element 192 reaches the receiving space, the arms deflect back to retain the magnetic element 192 in position.

As shown in FIG. 10, two opposing latch arms 177 extend outwardly from an interior surface 173 of the shutter body 172. The latch arms 177 are deflectable away from each other to receive a magnetic element 192. For example, each latch arm 177 defines a ramped or otherwise contoured surface to cam the latch arms 177 to the open position as the magnetic element 192 is being pressed towards the interior surface 173 of the shutter 170. Each latch arm 177 also defines a catch surface that engages the magnetic element 192 to retain the magnetic element 192 at the interior surface 173 of the shutter 170.

As shown in FIG. 7, the cradle 174 can be oriented so that the magnetic element 192 is slid downwardly along a height of the shutter 170 to mount the magnetic element 192 in the cradle 174. As shown in FIG. 11, the cradle 174 can instead be oriented so that the magnetic element 192 is slid sideways along the width of the shutter 170 to mount the magnetic element 192 at the cradle 174. In some examples, the mounting arrangement 175 is disposed along a central longitudinal axis C of the shutter 170 (e.g., see FIG. 7). In other examples, the mounting arrangement 175 is disposed offset from the central longitudinal axis C. In various examples, the shutters 170 can be configured to be disposed within different types of ports. For example, the shutter body 172 of FIG. 7 is configured to mount within a port of an LC optical adapter while the shutter body 172 of FIG. 11 is configured to mount within a port of an MPO optical adapter.

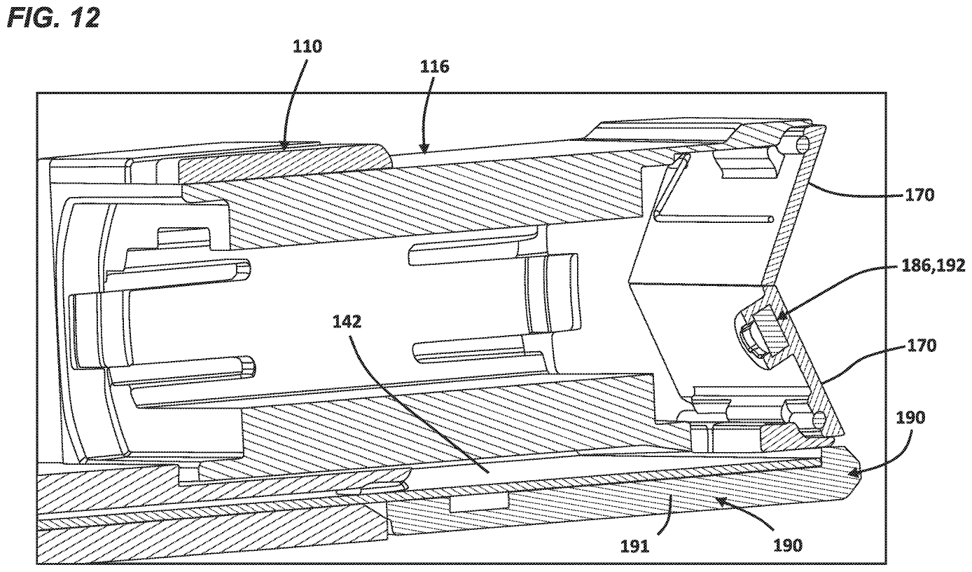

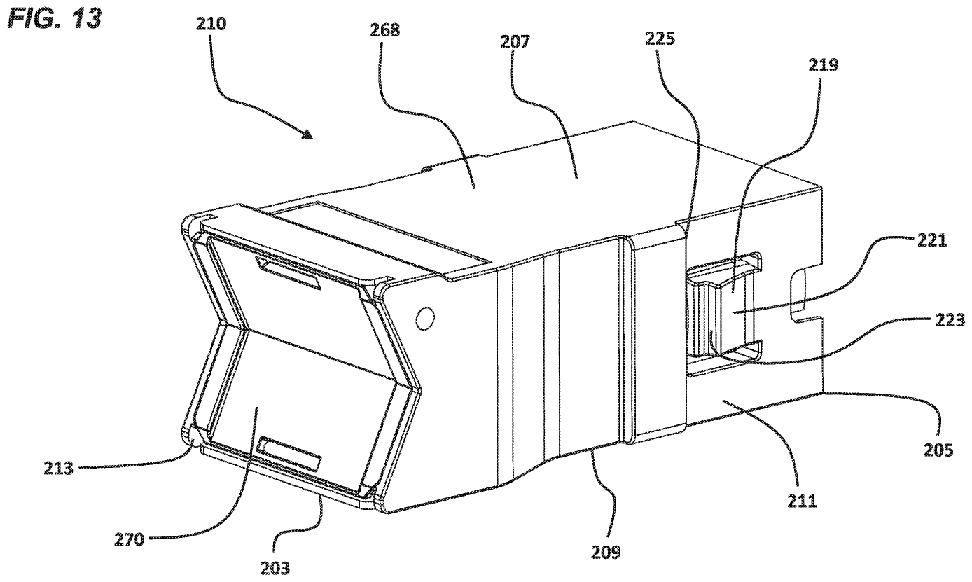

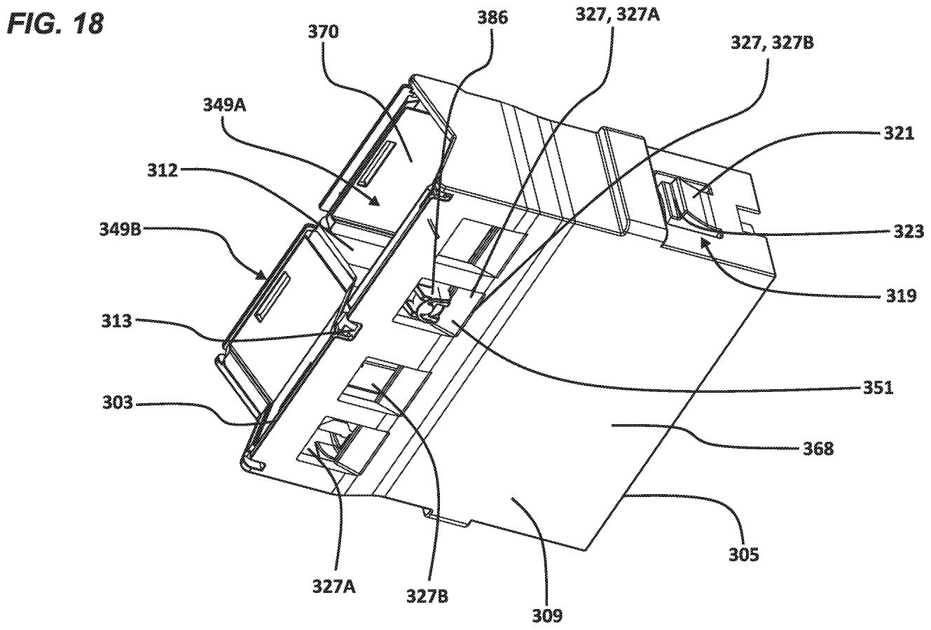

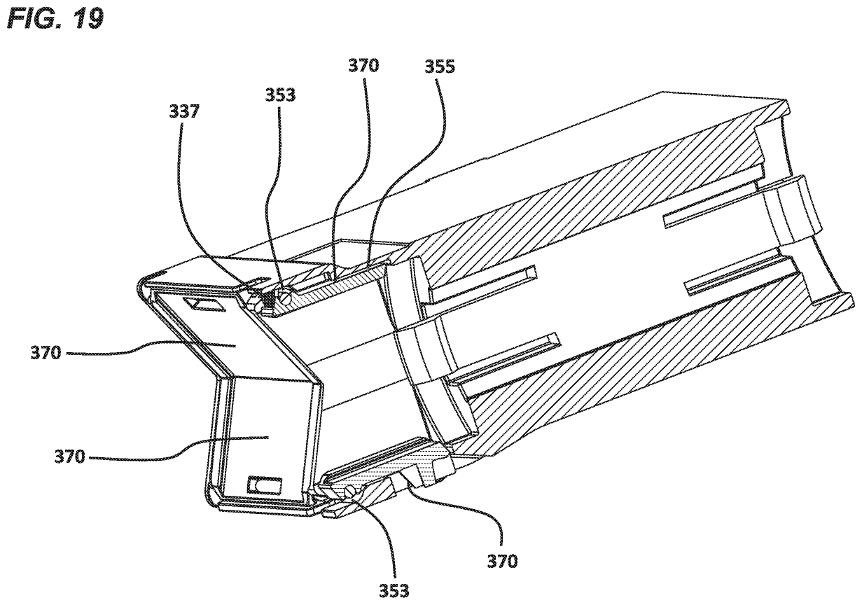

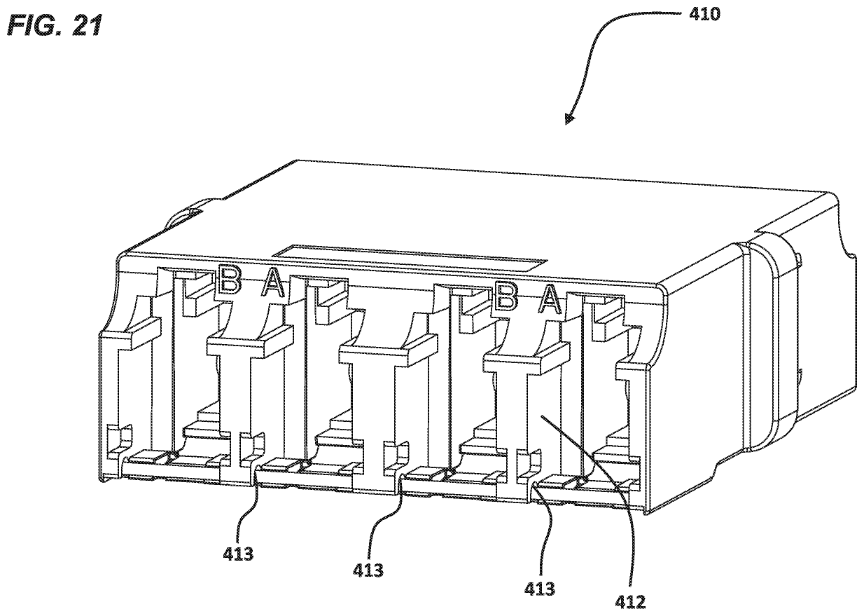

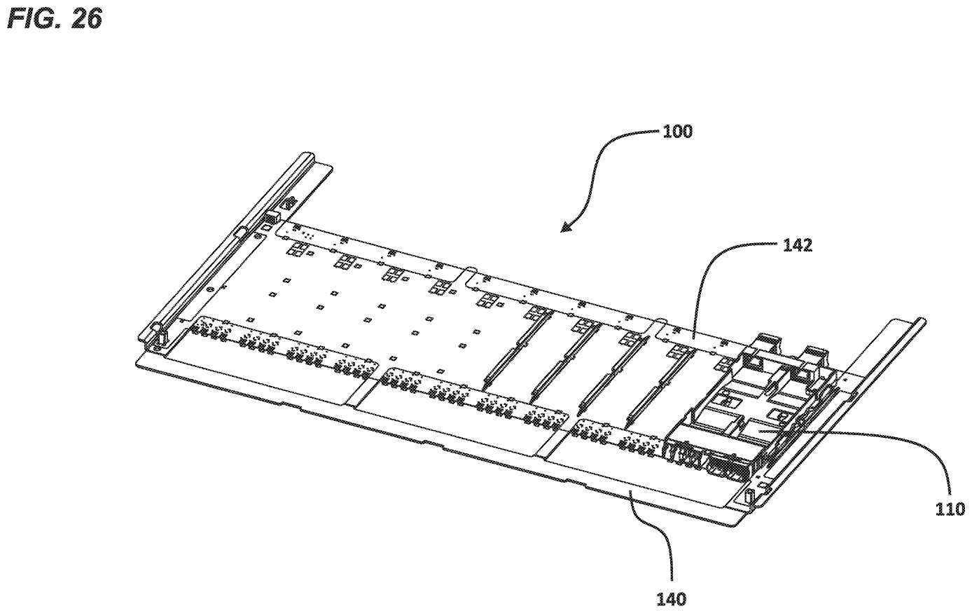

Referring to FIGS. 14-26, various adapters 210, 310, 410 are configured in accordance with the principles of the present disclosure to be selectively positioned at a cassette 110, which can be positioned within one or more bays 114 of a tray arrangement 100. In the example shown in FIGS. 14-17, the adapter 210 is a simplex MPO adapter. In the example shown in FIGS. 18-20, the adapter 310 is a duplex MPO adapter. In the example shown in FIGS. 21-26, the adapter 410 is a quad LC adapter. Other configurations are possible. The adapter 210, 310, 410 can include an adapter body 268, 368, 468 and one or more shutter doors 270, 370, 470. In certain implementations, the one or more shutter doors 270, 370, 470 can be operably coupled to the adapter body 268, 368, 468 via a hinge pin 202, 402. In embodiments, the adapter 210, 310, 410 can include a portion of the port occupancy detection feature (as described in connection with FIGS. 1-13) or a portion that interacts therewith.

The adapter body 268, 368, 468 extends along a depth between a front end 203, 303, 403 and a back end 205, 305, 405. The adapter body 268, 368, 468 also extends along a height between a top portion 207, 307, 407 and a bottom portion 209, 309, 409 and extends along a width between side portions 211, 311, 411. The height, width, and depth are transverse to each other. The adapter body 268, 368, 468 defines one or more forward ports (e.g., a space configured to receive one or more plug connectors) and a corresponding number of rear ports. For example, the adapter body 268 defines one forward port; the adapter body 368 defines two forward ports; and the adapter body 468 defines four forward ports.

As shown in FIGS. 14, 19, and 23, in certain implementations, the adapter body 268, 368, 468 can define a resilient latch member 219, 319, 419 configured to engage a stop surface on the cassette 110. In certain examples, the resilient latch member 219, 319, 419 is configured to be received within a latch window defined by a portion of the cassette 110. In certain examples, the resilient latch member 219, 319, 419 can include a ramp portion 221, 321, 421 and a stop portion 223, 323, 423. When the adapter body 268, 368, 468 is mounted to the cassette 110, a force or pressure exerted upon the ramp portion 221, 321, 421 causes the resilient latch member 219, 319, 419 to deflect inwardly. Upon removal of the force or pressure exerted upon the ramp portion 221, 321, 421, a natural material resiliency of the resilient latch member 219, 319, 419 can cause the resilient latch member 219, 319, 419 to resume its original shape so that stop portion 223, 323, 423 opposes a surface of the cassette 110, thereby inhibiting removal of the adapter body 268, 368, 468 from the cassette 110. In some implementations, the adapter body 268, 368, 468 can further define a second stop portion 225, 325, 425 spaced from and opposed to the first stop portion 223, 323, 423 such that a portion of the cassette 110 can be positioned between the first stop portion 223, 323, 423 and the second stop portion 225, 325, 425, thereby inhibiting movement of the adapter body 268, 368, 468 relative to the cassette 110 in either of the forward or rearward directions.

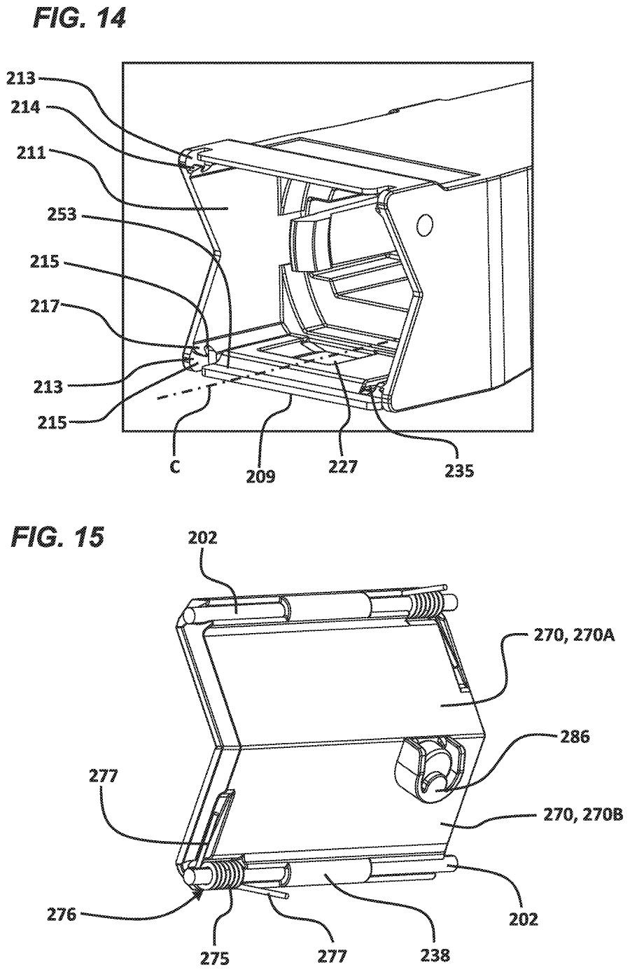

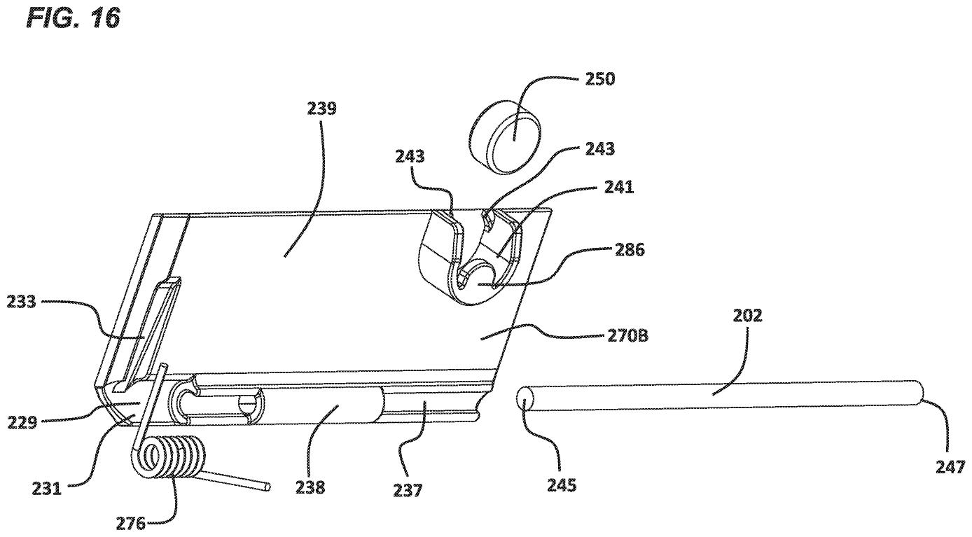

In some implementations, a bottom portion 209, 309, 409 of the adapter body 268, 368, 468 can define one or more port occupancy sensor arrangement windows 227, 327, 427 (as depicted in FIGS. 15, 19, and 23). The one or more windows 227, 327, 427 extend through the bottom portion 209, 309, 409 between an interior of the adapter body 268, 368, 468 and an exterior of the adapter body 268, 368, 468. In certain examples, the one or more port occupancy sensor arrangement window 227, 327, 427 can be horizontally offset from a centerline (C) of the adapter body 268, 368, 468. In some embodiments, the one or more port occupancy sensor arrangement window 227, 327, 427 can be configured to enable a portion of the shutter door 270, 370, 470 to be positioned therein. For example, the actuator 286, 386, 486 of the shutter door 270, 370, 470 can be at least partially positioned within the port occupancy sensor arrangement window 227, 327, 427 when the shutter door 270, 370, 470 is in the open position.

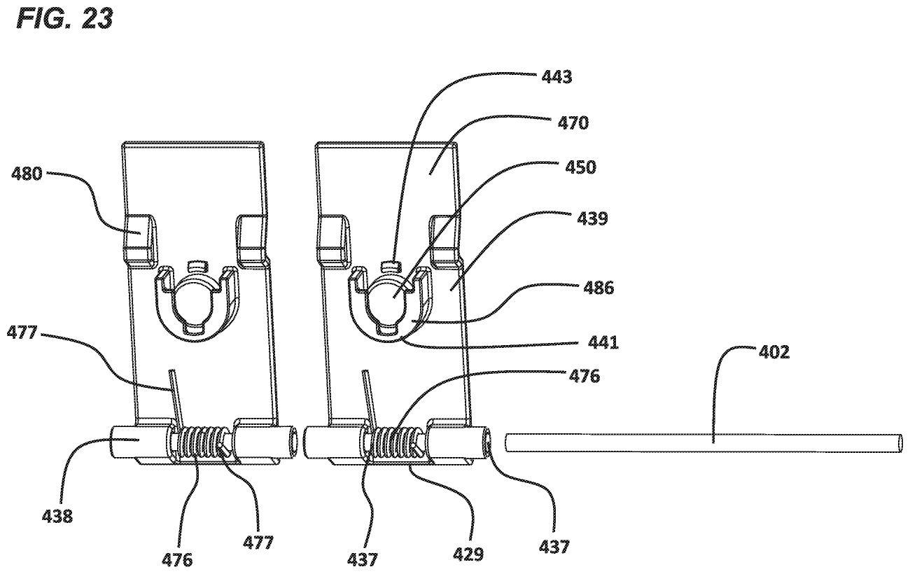

As best depicted in FIGS. 19 and 23, in some embodiments, a bottom portion 309, 409 of the adapter body 368, 468 can define a plurality of port occupancy sensor arrangement windows 327, 427. In certain examples, the spacing of the port occupancy sensor arrangement windows 327, 427 corresponds to the spacing of the ports (e.g., the forward ports ports). In some examples, the corresponding ports are single-fiber ports (e.g., see the ports of adapter 410). In such examples, each window 427 may be configured to receive the actuator 486 of a respective shutter 470 at the corresponding port. In other examples, the corresponding ports are multi-fiber ports (e.g., MPO ports). In such examples, multiple windows 227, 327 may be disposed at each port. A shutter 270, 370 disposed at the port may span the multiple windows 327 while the corresponding actuator 286, 386 may extend into only one of those windows 327. For example, an MPO port tends to have a width roughly twice that of an LC fiber port. Accordingly, as depicted in FIG. 19, a first MPO port 349A and the second MPO port 349B can each define two port occupancy sensor arrangement windows 327A, 327B, with only one port occupancy sensor arrangement window 327A actually being used during port occupancy sensing. Thus, as depicted in FIG. 19, the actuator 386 of the shutter door 370 partially extends through a first port occupancy sensor arrangement window 327A of the MPO port 349A. In the example shown, the second port occupancy sensor window 327B of the MPO port 349A remains vacant even when the respective shutter door 370 is open.

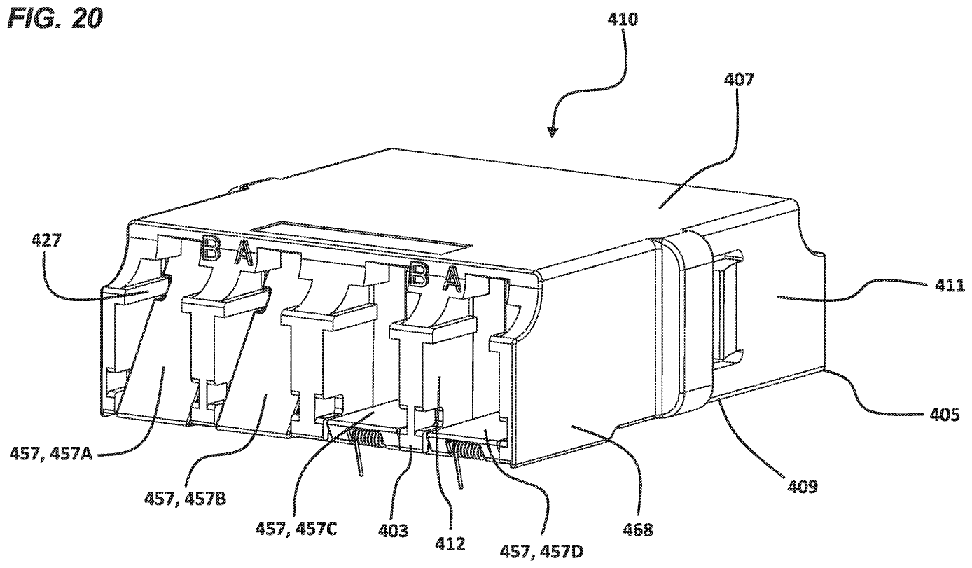

As further depicted in FIGS. 19-20, in examples, the port occupancy sensor arrangement windows 227, 327, 427 of the adapter bodies 268, 368, 428 can be shaped in size to accommodate various forms of port occupancy sensing. For example, in certain implementations, the port occupancy sensor arrangement windows 227, 327 can include a beveled edge 351. For example, the spring contact may have a ramped or contoured portion that protrudes through the window 227, 327 to be engaged by a plug connector 350 inserted into the port. In certain examples, the ramp or contour of the protruding spring contact portion may match or follow the shape or contour of the beveled edge 351 to account for mounting tolerances of the spring contact. It is noted that while the beveled edge is shown only on the first and second adapter bodies 268 368, the beveled edge also could be used at the window 427 of the fourth adapter body 468.

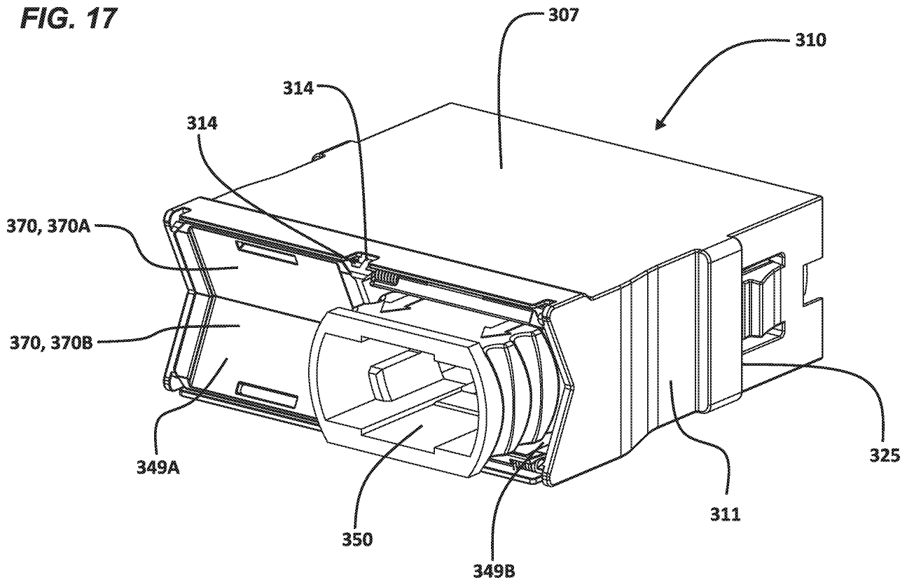

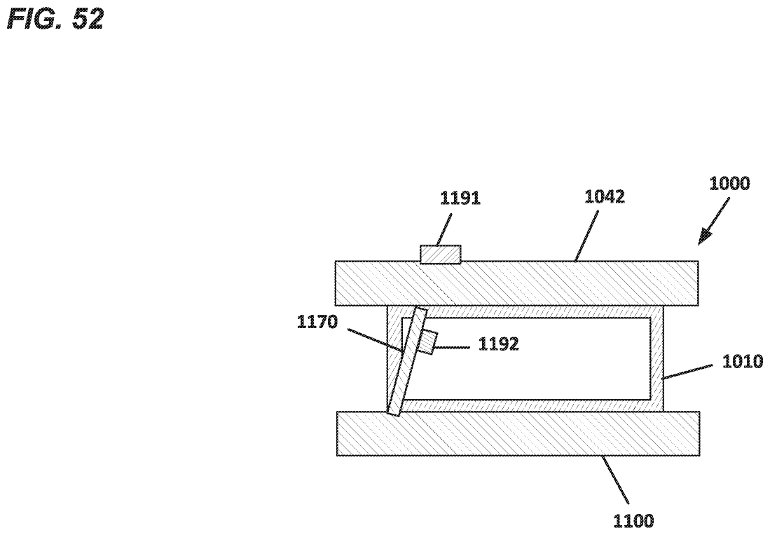

Referring now to FIGS. 16 and 23, in certain implementations, the actuator 286, 386, 486 can include a Hall effect element 250, 450 (e.g., magnetic element or the like) configured to interact with a noncontact sensor (e.g., Hall effect sensor) to indicate a position of the shutter door 270, 370, 470 as being in either of the open configuration or the closed configuration. For example, the actuator 286, 386, 486 can be carried by a cradle 241, 441 defined at an interior surface of the shutter door 270, 370, 470. The cradle 241, 441 can include at least one resilient stop 243, 443, which enables the Hall effect element 250, 450 to be inserted into the cradle 241, 441, but inhibits the Hall effect element 250, 450 from being removed from the cradle 241, 441 after insertion. In other implementations, the noncontact sensor can be disposed relative to the shutter door so that the actuator 286, 386, 486 is within sensing range of the noncontact sensor when the shutter door 270, 370, 470 is closed and leaves the sensing range when the shutter door 270, 370, 470 is open. For example, in FIG. 52, an example port member 1010 is mounted to a support structure 1100 (e.g., a tray, a frame, a drawer, etc.). The port member 1010 has a shutter door 1192 carrying an actuator 1192 (e.g., a magnetic element such as a magnet). A circuit board 1042 is mounted (e.g., fastened, latched, snap-fit, etc.) to the port member 1010 opposite the support structure 1100. A noncontact sensor (e.g., Hall effect sensor) 1191 is mounted to the circuit board 1042. Movement of the shutter door 1170 from the closed position to the open position beings the magnetic element 1192 out of sensing range of the sensor 1191. In other embodiments, an inside surface 239, 439 of the shutter door 270, 370, 470 can define the actuator 286, 386, 486. For example, the actuator 286, 386, 486 can be configured to actuate a spring contact resulting in the breaking of an electrical connection between the spring contact and an interfacing surface, thereby indicating that the shutter door 270, 370, 470 is in an open configuration (e.g., which may lead to an inference that the port defined by the adapter body 268, 368, 468 is occupied).

Each shutter door 270, 370, 470 is configured to pivotally mount at a respective port of the adapter body 268, 368, 468. In certain implementations, a hinge pin 202 extends along a receiving channel 237 of the shutter door 270, 370, 470 to secure the shutter door 270, 370, 470 to the adapter body 268, 368, 468. In certain implementations, a door spring 276, 476 (e.g., a torsion spring) is secured to the shutter door 270, 370, 470 using the hinge pin 202. For example, the hinge pin 202 can extend through a coil of the door spring 276, 476 with a first end 277, 477 of the spring 276, 476 applying a bias against the shutter door 270, 370, 470 and a second end 277, 477 of the spring 276, 476 applying a bias against the adapter body 268, 368, 468.

In certain implementations, the adapter body 268, 368 includes multiple shutter doors 270, 370 disposed at each port receptacle. The shutter doors 270, 370 cooperate to block access to the respective port when the shutter doors 270, 370 are disposed in the closed position. The shutter doors 270, 370 provide access to the respective port when disposed in the open position. In the example shown in FIG. 14-20, a first (e.g., upper) shutter door 270A and a second (e.g., lower) shutter door 270B are disposed within each port receptacle. Each of the shutter doors 270, 370 is pivotably coupled to the adapter body 268, 368 so as to enable transition between a closed configuration (e.g., such as that depicted in FIG. 14) and an open configuration. In the example shown in FIG. 18, the first MPO port 349A is unoccupied such that the shutter doors 370 are generally in a closed configuration and the second MPO port 349B is occupied by an MPO style plug 350 (an outer portion of which is visible in FIG. 18) such that the shutter doors 370 are generally in an open configuration. The plug 350 is omitted in FIG. 20 for ease in viewing the shutter doors 370.

When in the open configuration, a major surface of the shutter door 270, 370 is substantially parallel with the respective top portion 207, 307 and bottom portion 209, 309 of the adapter body 268, 368. In examples, the MPO adapter 210, 310 can be utilized with the port identification and/or port occupancy detection feature (as described in connection with FIGS. 1-13). In certain examples, only one of the shutter doors 270A of each receptacle carries a presence sensor actuator 286. The port occupancy actuator 286 (or portion of the shutter door 270, 370 holding the same) at least partially protrudes into the respective window 227, 327 when the shutter door 270, 370 is disposed in the open position.

In the closed configuration, the shutter doors 270, 370 can generally be angled inwardly. In certain examples, a hinged connection between the shutter doors 270, 370 and the adapter body 268, 368 is generally positioned at the front end 203, 303 of the cassette body 268, 368 and the pivoting free ends of the shutter doors 270, 370 are generally positioned aft of the front end 203, 303. This configuration of the doors 270, 370 generally reduces the amount of force necessary to transition the shutter doors 270, 370 from the closed configuration to the open configuration to position an MPO plug into the MPO port 349A, 349B.

In certain implementations, each of the shutter doors 270, 370, 470 can define a hinge pin receiving passage 237, 437. The hinge pin 202, 402 seats in the passage 237. In some implementations, the receiving passage 237 defines a groove (e.g., a partial cylindrical impression) extending at least partially along one edge of the shutter door 270, 370. In certain examples, the shutter door 270, 370, 470 can define a spring receiving pocket 229 axially aligned with the channel 237. In some examples, a groove 233 may extend outwardly from the pocket 229 to accommodate one end 277 of the door spring 276. In other examples, the end 477 of the door spring 476 extends over an inner surface of the shutter door 470.

In certain examples, ends 245, 247 of the hinge pin 202 extend axially outwardly from the passage 237 to engage portions of the adapter body 268, 368. For example, the section 238 may be disposed at a central region of the receiving channel 237. Accordingly, in some embodiments, the adapter body 268, 368 can be assembled by positioning the door springs 276 within the torsion spring receptacle 229 defined by each shutter door 270, 370. With the torsion spring 276 in position, the hinge pin 202 can be slid axially into the hinge pin receiving channel 237 and through the body 275 of the torsion spring 276, such that the hinge pin 202 serves to retain the torsion spring 276 within the torsion spring receptacle 229.

In other implementations, the receiving passage 437 defines a through-passage extending through one or more pivot ends 438 (e.g., cylindrical structures) of the shutter door 470. For example, the shutter door 470 includes two pivot ends 438 protruding outwardly from opposite sides of the shutter door 470 with each pivot end 438 defining a through-passage 437. In the example shown, the door spring 476 is axially aligned with the through-passage between the pivot ends 438. In certain examples, a shutter door 270, 370 can define both a channel and a through-passage along a width of the shutter 270, 370 (e.g., see FIG. 16). In other implementations, no portion of the shutter door 270, 370 completely encircles the hinge pin 202, which can reduce frictional losses between the hinge pin 202 and the shutter door 270, 370 during operation. Further, less material is needed to manufacture such a shutter door 270, 370.

In certain implementations, the adapter body 268, 368, 468 further defines one or more mounting receptacles 213, 313, 413 at which the shutter doors 270, 370, 470 mount to the adapter body 268, 368, 468. In some implementations, the mounting receptacles 213, 313 receive and hold the ends of the hinge pin 202. For example, the ends of a hinge pin 202 can snap-fit into the mounting receptacles 213, 313 (e.g., see FIG. 15). In certain such implementations, the adapter body 268, 368 also defines a groove 253, 353 or other recess to accommodate the pivot end of the shutter door 270, 370 as the door 270, 370 pivots between the open and closed positions.

In certain implementations, one or more of the receptacles 213, 313, 413 may include a stop surface against which an end of the hinge pin 202, 402 can abut to inhibit axial movement of the hinge pin 202, 402 relative to the adapter body 268, 368, 468. In other implementations, one or more of the receptacles 213, 313, 413 may define through-passages through which a hinge pin 202, 402 may extend. In certain implementations, the adapter body 268, 368 includes mounting receptacles 213, 313 at the inner sides of the sidewalls 211, 311 of the adapter body 268, 368. In the examples shown, mounting receptacles 213, 313 413 at the sidewalls 211, 311, 411 include the stop surface (e.g., the inner side of the sidewall 211, 311, 411). In other examples the hinge pin 202, 402 could extend through the sidewalls 211, 311, 411.

In certain examples, the adapter 310 also includes mounting receptacles 313 at one or more dividers 312 between the forward ports. Accordingly, a first hinge pin 202 may extend between a mounting receptacle 313 at a first sidewall 311 of the adapter body 368 and a mounting receptacle 313 at the adjacent divider 312. In some examples, the dividers define a stop surface at the mounting receptacles 313 so that each divider 312 defines two mounting receptacles 313—one on each side. In other examples, the mounting receptacles 313 extend fully through the dividers 312 so that two hinge pins 202 can be received from opposite ends of the same mounting receptacle 313.

Referring to FIG. 15, in some implementations, the mounting receptacle 213, 313 can include a recess 215 configured to retain one end 245, 247 of a hinge pin 202 of a shutter door 270, 370. A resilient retainer 217 also can be positioned at the recess 215 (e.g., see FIG. 15). The retainer 217 is configured to temporarily flex to enable a portion of the hinge pin 202 to be positioned within the recess 215 and then to naturally spring back to its original shape under a natural material resiliency to inhibit removal of the hinge pin 202 from the recess 215. In certain implementations, each hinge pin receptacle 213 includes a ramped surface 214 leading to the recess 215. For example, the ramped surface 214 may lead from an exterior of the adapter body 268, 368. In an example, the ramped surface 214 is wider at the recess 215 than at an opposite end of the ramped surface 214. The shutter door 270, 370 can be pivotably coupled to the adapter body 268, 368 by snapping a respective first end 245 and a second end 247 in the hinge pin receptacles 213 defined by the adapter body 268, 368.

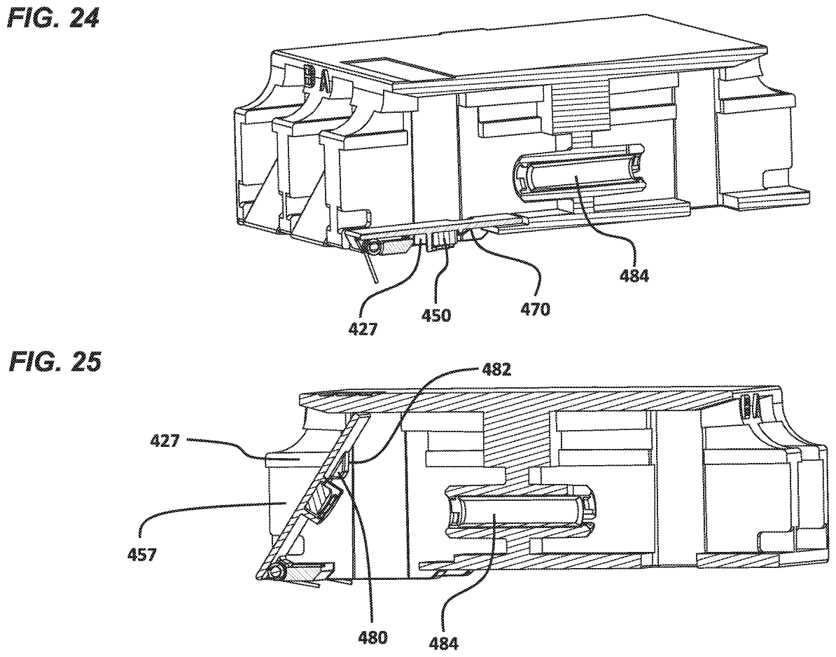

In other implementations, the mounting receptacles 413 receive and engage pivot ends 438 of the shutter door 470 (e.g., see FIG. 23). For example, as shown in FIG. 24, the pivot ends 438 can include hollow cylinders extending outwardly from the shutter door. As discussed above, the pivot ends 438 may define the passage through which the hinge pin 402 extends. In certain implementations, the adapter body 468 defines a channel 415 or other recess extending along a width of the adapter body 468. The channel 415 is accessible from a bottom of the adapter body 468. In certain examples, a gap between the lips or longitudinal edges of the channel 415 is smaller than a cross-dimension (e.g., diameter) of the pivot end 438 of the shutter door 470 so that the pivot end 438 is held within the channel 415 by a natural resiliency of the adapter body 468. In some examples, the adapter body 468 includes a single channel 415 that extends along the width of the adapter body 468 and receives pivot ends of each of the shutter doors 470. In other examples, the adapter body 468 includes multiple channels 415 spaced between the dividers 412 (e.g., see FIG. 23) so that the dividers define stop surfaces between adjacent channels 415.

In certain examples, the shutter doors 470 are coupled via one or more hinge pins 402. In some implementations, each shutter door 470 is secured to the adapter body 468 using a respective hinge pin 402. In other implementations, a single hinge pin 402 can span the width of more than a single shutter door 470 so that multiple shutter doors 470 can be mounted to the same hinge pin 402. Mounting multiple shutter doors 470 to the same hinge pin 402 may facilitate assembly given the small size of the components. For example, the shutter doors 470 can be assembled on the hinge pin 402 external of the adapter body 468 and then mounted within the channel 415 as a unit. In certain examples, the single hinge pin 402 can extend across a majority of a width of the adapter body 468 to engage mounting receptacles 413 at opposite sidewalls 411 of the adapter body 468. In other examples, multiple hinge pins 402 cooperate to extend across a majority of the width of the adapter body 468 with each hinge pin 402 spanning two or more ports.

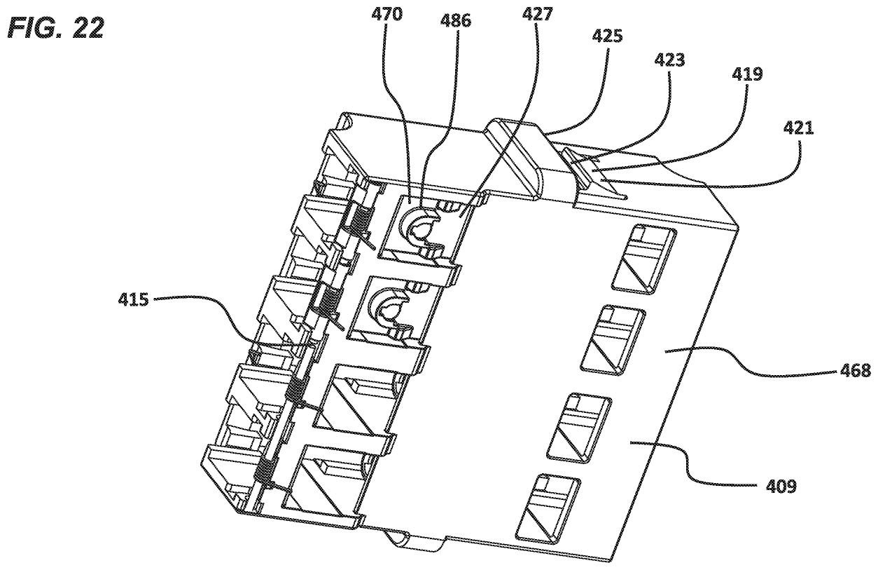

As further depicted, in some embodiments, each of the shutter doors 470 can include one or more limiters 480 configured to engage with a portion of the adapter body 468 to inhibit over travel of the shutters 312, 352, 382, 402 past the closed position. Each contoured portion 480 defines a pocket 482. For example, as best depicted in FIGS. 21 and 22, certain types of the adapter body 468 can define a limiter 472 (e.g., an inwardly protruding ledge) within the port. When the shutter door 470 is closed, the ledge 472 nests within the pocket 482 defined by the shutter door 470.

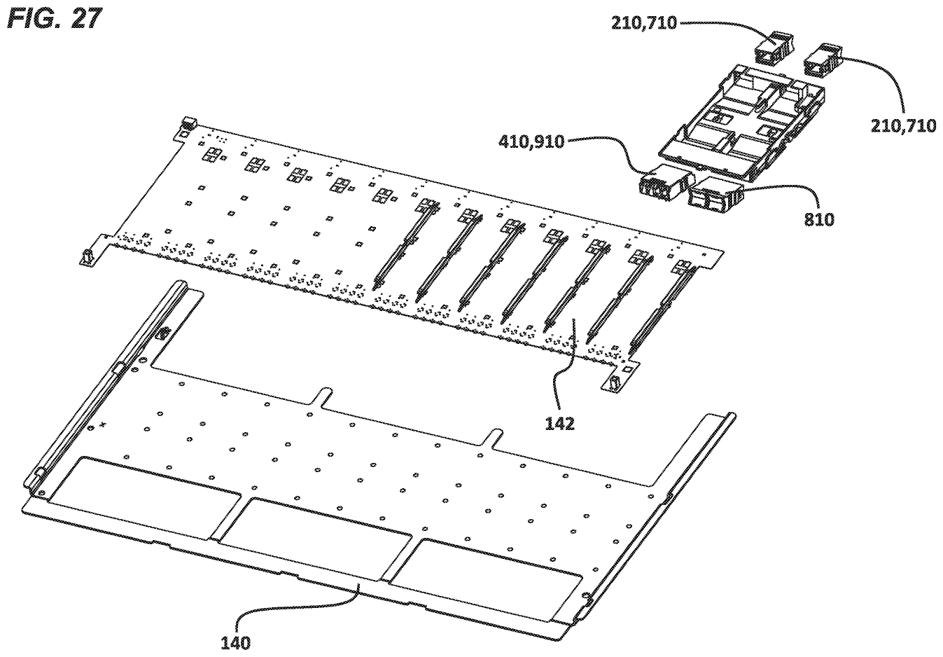

Referring to FIGS. 26-28, a tray arrangement 100 having a port occupancy detection feature suitable for use with any of the adapters 210, 310, 410, 710, 810, 910 discussed herein is depicted in accordance with an embodiment of the disclosure. In certain examples, the tray arrangement 100 also has a cassette identification feature. As depicted, the tray arrangement 100 can include a tray base 140 and a circuit board 142. In embodiments, the tray arrangement 100 can define one or more cassette guides 112 defining one or more bays 114 for the receipt of one or more cassettes 110. Each cassette 110 is configured to hold two or more adapters 210, 310, 410 at a front of the cassette 110 and one or more adapters 210, 310, 410 at the rear of the cassette 110.

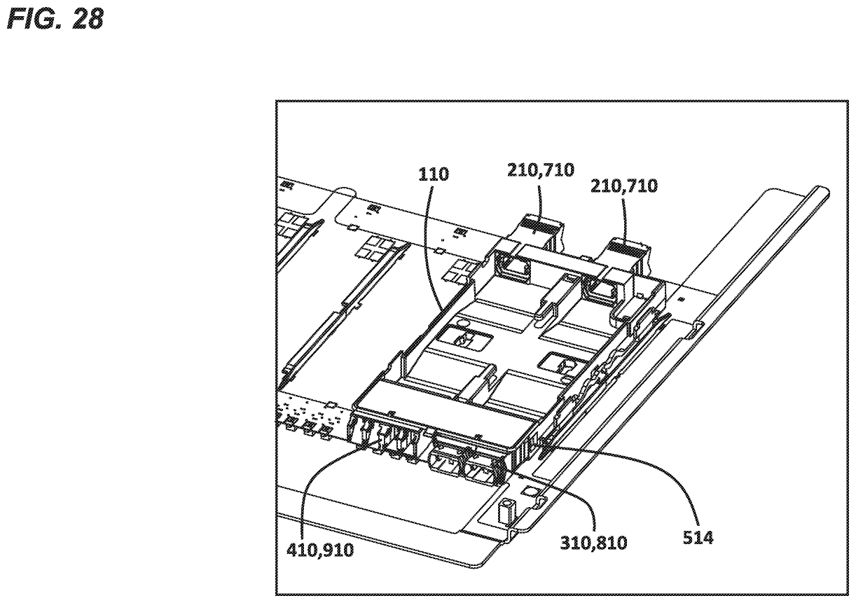

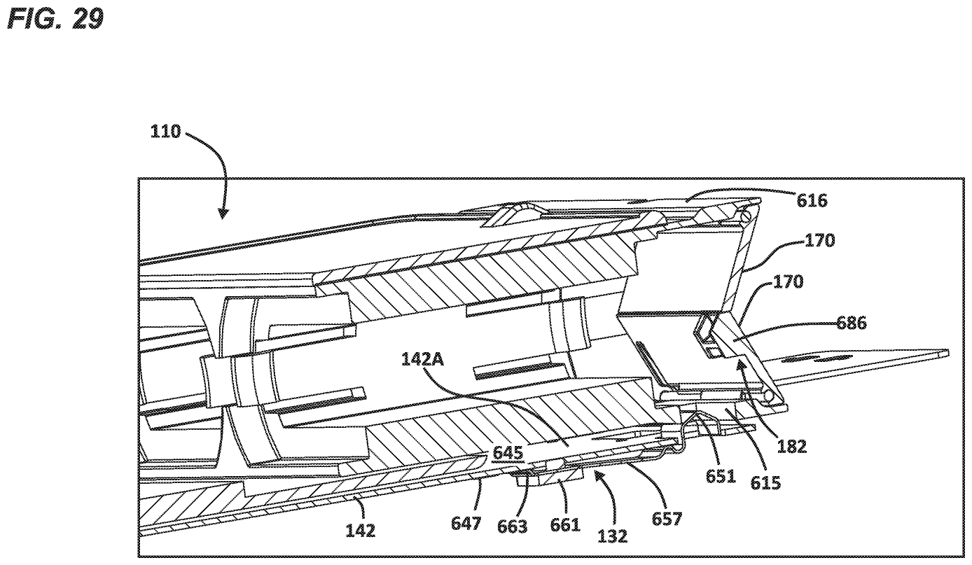

In the example depicted in FIG. 28, a quad LC adapter 410 (as depicted in FIGS. 21-26) and a duplex MPO adapter 310 (as depicted in FIGS. 18-20) are shown mounted to the front of the cassette 110 and two simplex MPO adapters 210 (as depicted in FIGS. 14-17) are shown mounted to the rear of the cassette 110; although the use of other types of adapters also is contemplated. In other implementations, the cassette 110 is configured to receive one type of adapters 210, 310, 410 at the front and a different type of adapters 210, 310, 410 at the rear. One example cassette 110 suitable for use with any of the adapters 210, 310, 410 disclosed herein is shown in FIG. 29.

The cassette 110 defines windows 514 at which the resilient latch members 219, 319, 419 of the adapters 210, 310, 410 engage. For example, the cassette 110 can define such windows 514 at the front and at the rear of the cassette 110. The cassette 110 is configured to space the adapters 210, 310, 410 to align the bottom windows 227, 327, 427 of the adapters 210, 310, 410 (e.g., the front adapters) with port occupancy detection features on the circuit board 142. Accordingly when a plug connector is received at the port, the plug connector opens the shutters, which carries the actuator 186, 286, 386, 486 through the adapter window 227, 327, 427 and into engagement or other interaction with the port occupancy detection features. In certain implementations, the cassette 110 either has windows or has a recessed bottom surface that exposes the bottom windows 227, 327, 427 of the adapters 210, 310, 410 (e.g., the front adapters).

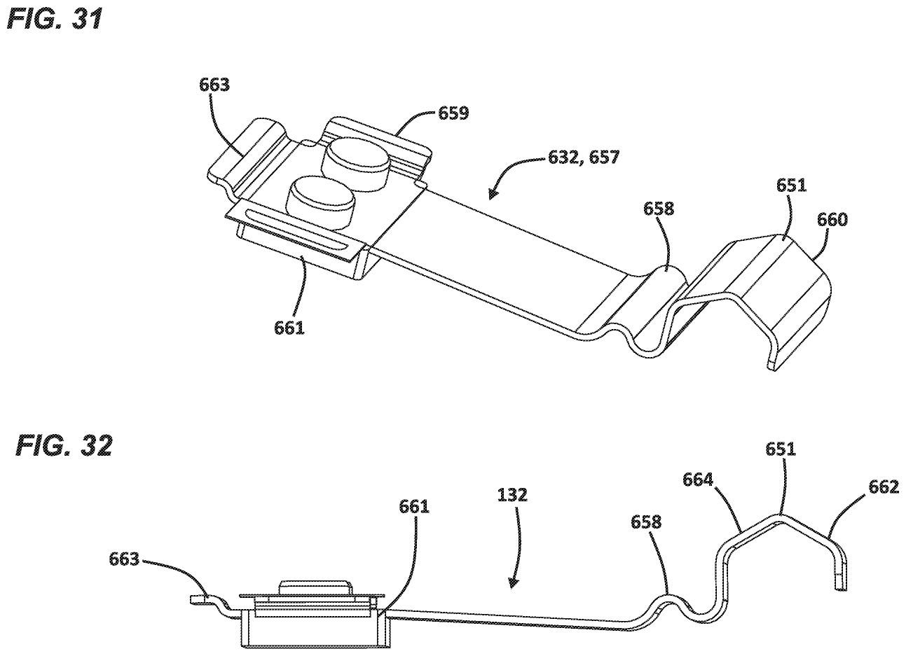

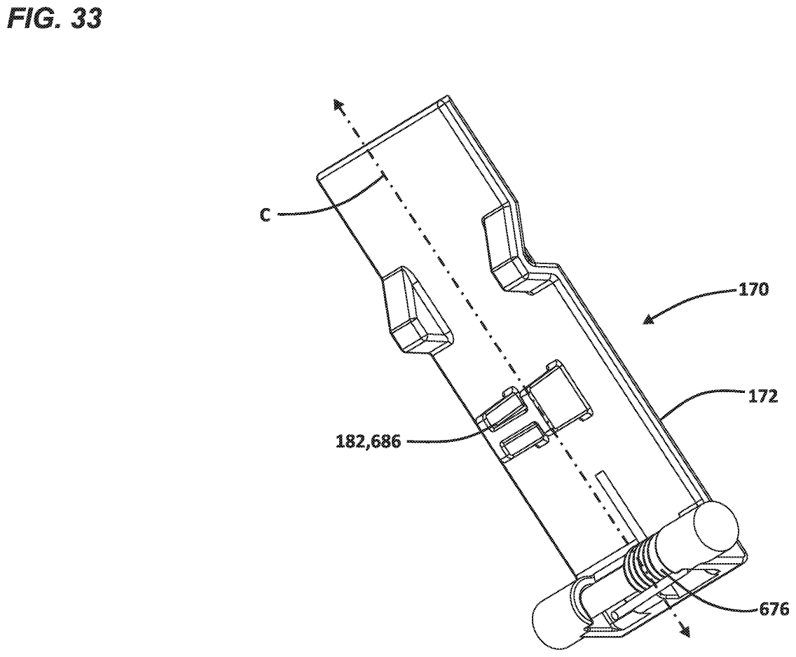

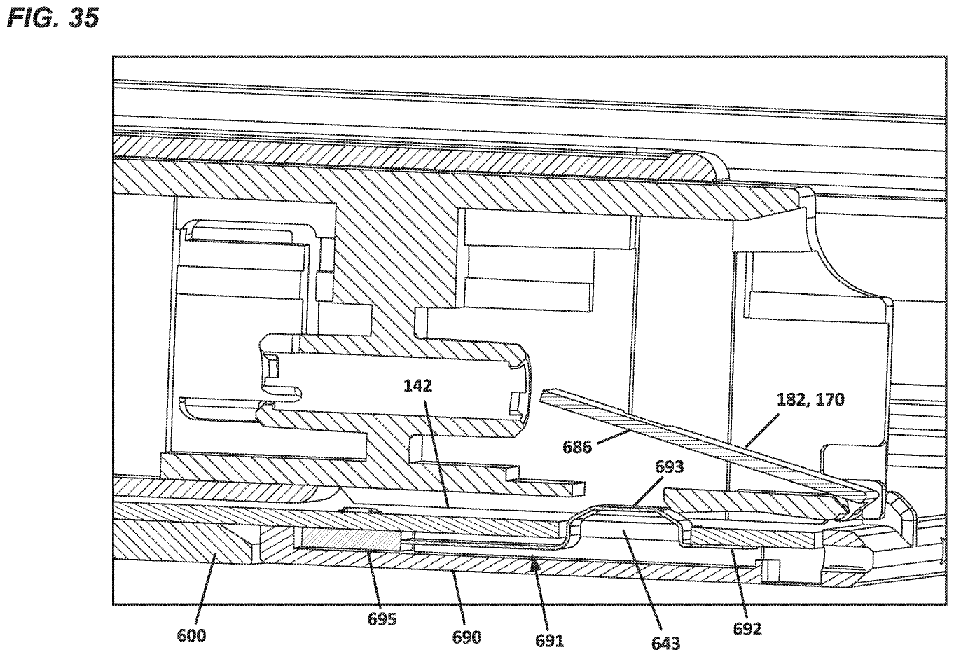

FIGS. 29-32 illustrate first and second portions 132, 182 of a second example port occupancy sensor arrangement suitable for use with a tray arrangement 600 and the cassettes 110 of FIGS. 1-3. FIGS. 35-38 illustrate first and second portions 132, 182 of a third example port occupancy sensor arrangement suitable for use with the tray arrangement 600 and the cassettes 110 of FIGS. 1-3.

In certain implementations, the first portion 132 of the port occupancy sensor arrangement includes a contact spring 657, 691 mounted to the circuit board 142 (e.g., see FIGS. 29 and 35). Accordingly, the cassette 110 moves relative to the contact spring 657, 691 as the cassette 110 is mounted to the tray arrangement 600. In certain implementations, the contact spring 657, 691 is mounted to an opposite side of the circuit board 142 from the cassette 110. In certain implementations, a portion 660, 693 of the contact spring 657, 691 protrudes through the circuit board 142 to be engaged by the actuator 686 of the cassette 110 when a plug is received at a port of the cassette 110. In certain implementations, the actuator 686 is carried by a dust shutter 170 at the port.

The circuit board 142 has a first major side 645 and a second major side 647. In certain implementations, when the circuit board 142 is mounted to the tray arrangement 600, the second major side 647 of the circuit board 142 faces the tray arrangement 600 and the first major side 645 faces away from the tray arrangement 600. In certain examples, the cassette 110 is disposed at the first major side 645 and the contact spring 650 is disposed at the second major side 647 so that the circuit board 142 extends between the cassette 110 and the contact spring 650. The circuit board 142 includes a contact interface location disposed at the second major side 647. The circuit board 142 defines a window 643 extending between the first and second major surfaces 645, 647.

The contact spring 657, 691 is fixed to the circuit board 142 at a mounting section 661, 695 of the contact spring 657, 691. The contact spring 657, 691 extends outwardly from the mounting section 661, 695 in a cantilever configuration. In certain examples, the mounting section 661, 695 is formed of a different material than a remainder of the contact spring 657, 691. In an example, the mounting section 661, 695 is over-molded around the remainder of the contact spring 657, 691. In certain implementations, the mounting section 661, 695 includes pegs

The contact spring 657, 691 has a first contact surface 658, 692 that is movable (e.g., deflectable or pivotable) between a first position and a second position. The first contact surface 658, 692 aligns with and engages a contact interface location of the circuit board 142 when the contact spring 657, 691 is disposed in the first position. The first contact surface 658, 692 is spaced from the contact interface location when the contact spring 657, 691 is disposed in the second position. In certain implementations, the contact spring 657, 691 also includes a second contact surface 663, 697. The contact spring 657, 691 selectively electrically connects the first contact interface location with a second contact interface location of the circuit board 142 via the first and second contact surfaces.

In certain implementations, the contact spring 657, 691 is biased towards the first position. In certain examples, the contact spring 657, 691 is self-biased towards the first position. In some implementations, the first position is an undeflected position and the second position is a deflected position of the contact spring 657, 691. In other implementations, the contact spring 657, 691 is disposed in a pre-loaded state (e.g., at least slightly deflected) at the contact interface location when in the first position.

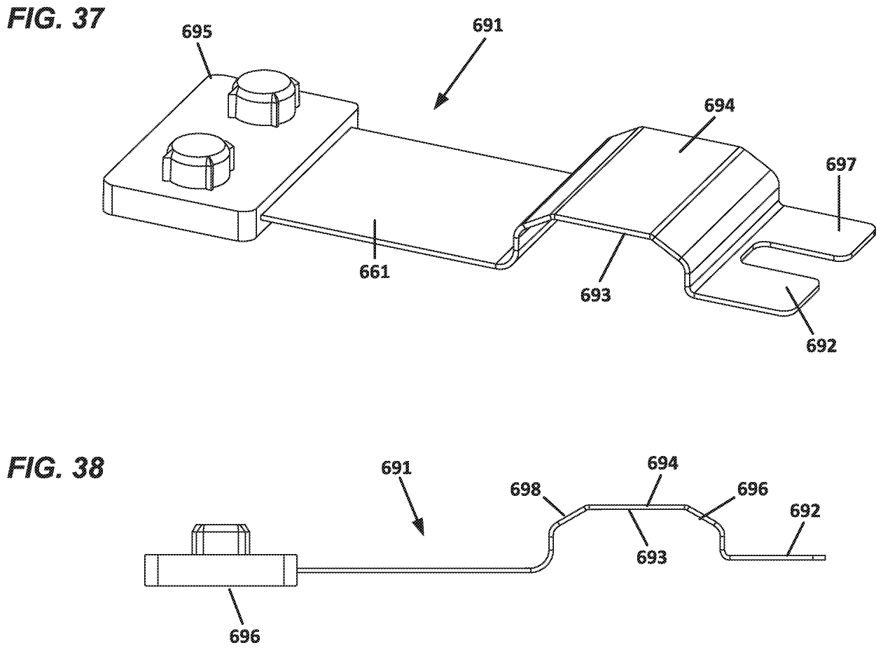

In some implementations, the second contact surface 663 is fixedly engaged with a second contact interface location of the circuit board 142 (e.g., see FIG. 29). For example, another portion of the contact spring 657 can be cantilevered off the mounting section 661 to extend towards the second contact interface location on the circuit board 142. In certain examples, the another portion extends opposite the main cantilevered portion of the contact spring 657. In the example shown in FIG. 31, the contact spring 657 also includes wings 659 that also engage the second contact interface location on the circuit board 142 to further ensure a secure electrical connection between the contact spring 657 and the second contact interface location. In other implementations, the second contact surface 697 is carried with the cantilevered portion of the contact spring 657, 691 to move towards and away from the second contact interface location of the circuit board 142 (e.g., see FIG. 37). For example, the first and second contact surfaces 692, 697 may be laterally spaced at a common location along the length of the contact spring 691.

When the contact spring 657, 691 is disposed in the first position, electrical current runs along the contact spring 657, 691 between the first and second contact interface locations. When the contact spring 657, 691 is disposed in the second position, the electrical connection between the first and second contact interface locations is broken. In certain implementations, the circuit board 142 includes a processor configured to detect the break in the electrical circuit and to cause the generation of a port detection signal.

In certain implementations, the contact spring 657, 691 includes an actuation surface 651, 694 configured to engage with the actuator 686 of a cassette 110. In certain examples, the protruding portion 660, 693 of the contact spring 657, 691 forms the actuation surface 651, 694. Depressing the actuation surface 651, 694 moves the contact surface 658, 692 to the second position by flexing, pivoting, or otherwise moving the contact spring 657, 691 relative to the mounting section 661, 695.

In certain implementations, the contact surface 658 is disposed along the length of the contact spring 657 between the actuation surface 651 and the mounting section 661. In other implementations, the actuation surface 694 is disposed along the length of the contact spring 691 between the contact surfaces 692, 697 and the mounting section 695. In the example shown in FIG. 31, the contact surface 658 is disposed between the actuation surface 651 and the mounting section 661 when the second contact surface 663 is fixedly mounted to the second contact interface location. It will be understood, however, that the actuation surface 651 could be disposed between the contact surface 658 and the mounting section 661 in such a configuration. In the example shown in FIG. 37, the actuation surface 694 is disposed between the contact surface 692 and the mounting section 695 when the second contact surface 697 is movably mounted to the second contact interface location. It will be understood, however, that the contact surface 692 could be disposed between the actuation surface 694 and the mounting section 695 in such a configuration.

Referring now to FIGS. 29 and 35, in certain implementations, the cassette 110 or corresponding port member 616 includes a body defining an aperture 615 aligned with the window 643 defined in the circuit board 142. When the shutter 170 is moved to the open position, the actuator 686 protrudes through the aperture 615 of the cassette 110 towards the window 643 in the circuit board 142. When the shutter 170 is disposed in the open position, the actuator 686 contacts the actuation surface 651, 694 of the contact spring 657, 691 to move at least the contact surface 658, 692 away from the circuit board 142 to break the electrical connection.

In certain implementations, the portion 660, 693 of the contact spring 657, 691 that protrudes through the circuit board 142 has a forward-facing ramped or otherwise contoured surface 662, 696 and a rearward-facing ramped or otherwise contoured surface 664, 698. When a cassette 110 is mounted to the tray arrangement 600, the cassette 110 is slid over the circuit board 142 (e.g., over the first major surface 645 of the circuit board 142) and over the protruding portion 660, 693. The forward-facing ramped surface 662, 696 deflects the contact spring 657, 691 downwardly when engaged by a rear end of the cassette 110 to accommodate rearward sliding movement of the cassette 110 when the cassette 110 is mounted from the front of the tray arrangement 600. The rearward-facing ramped surface 664, 698 deflects the contact spring 657, 691 downwardly when engaged by a front end of the cassette 110 to accommodate forward sliding movement of the cassette 110 when the cassette 110 is mounted from the rear of the tray arrangement 600.

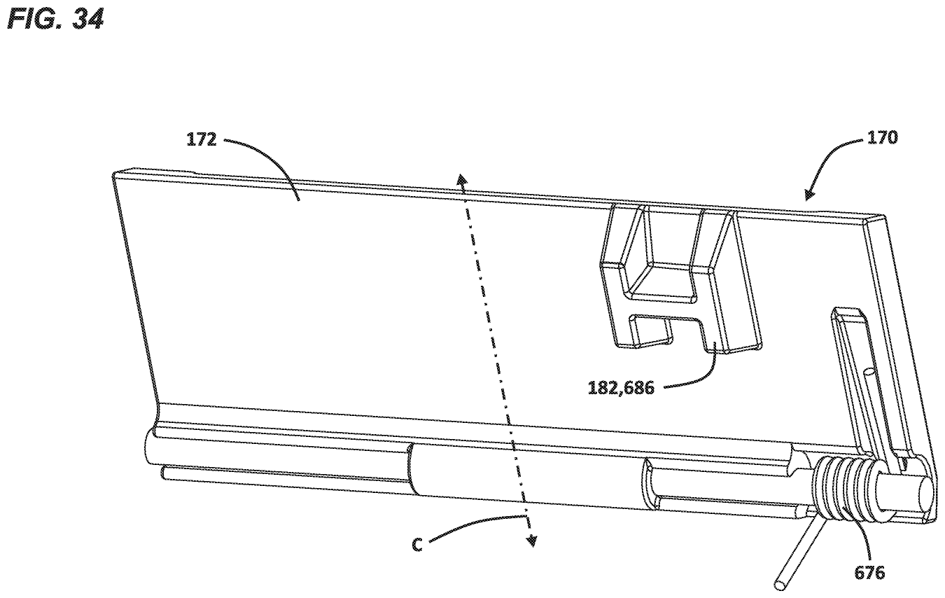

FIGS. 33 and 34 illustrate first and second example actuators 686 carried by example shutters 170 configured to be disposed at the front port of a cassette 110. FIG. 33 illustrate a shutter 170 suitable for use in an LC fiber optic adapter port and FIG. 34 illustrates a shutter 170 suitable for use in an MPO fiber optic adapter port. The shutter 170 includes a body 172 configured to extend across the front port when in a closed position. The shutter body 172 is configured to move relative to the port member 616 to an open position in which access is provided to the front port. For example, the shutter body 172 may pivot or deflect to the open position. In certain examples, the shutter body 172 is biased to the closed position. In certain examples, the shutter body 172 is biased closed by a torsion spring 676.

In certain examples, the actuator 686 extends inwardly from an interior surface of the shutter body 172. In some examples, the actuator 686 is disposed along a central longitudinal axis C of the shutter body 172 (e.g., see FIG. 33). In other examples, the actuator 686 is offset from the central longitudinal axis C (e.g., see FIG. 34). In certain examples, the actuator 686 is monolithically formed with the shutter body 172. In certain implementations, the actuator 686 spans a majority of a width of the shutter body 172 (e.g., see FIG. 33). In certain implementations, the actuator 686 is disposed at an end of the shutter body 172 (e.g., see FIG. 34).

Referring to FIGS. 29 and 35, in some implementations, the circuit board 142 extends forwardly past the front of the tray arrangement 600 so that a portion 142A of the circuit board 142 is disposed forward of the tray arrangement 600. In certain examples, the contact spring 650 is mounted to the portion 142A of the circuit board 142. In certain implementations, a bezel 690 is mounted to the circuit board 142 to cover the portion 142A. In certain examples, the bezel 690 covers the contact spring 691. The bezel 690 defines a pocket or recess in which the contact spring 657, 691 can move relative to the bezel 690. In other implementations, the tray arrangement 600 defines cutouts or other recesses to accommodate the contact springs 650. In certain such implementations, the tray arrangement 600 may extend forwardly at least as far as the circuit board 142.

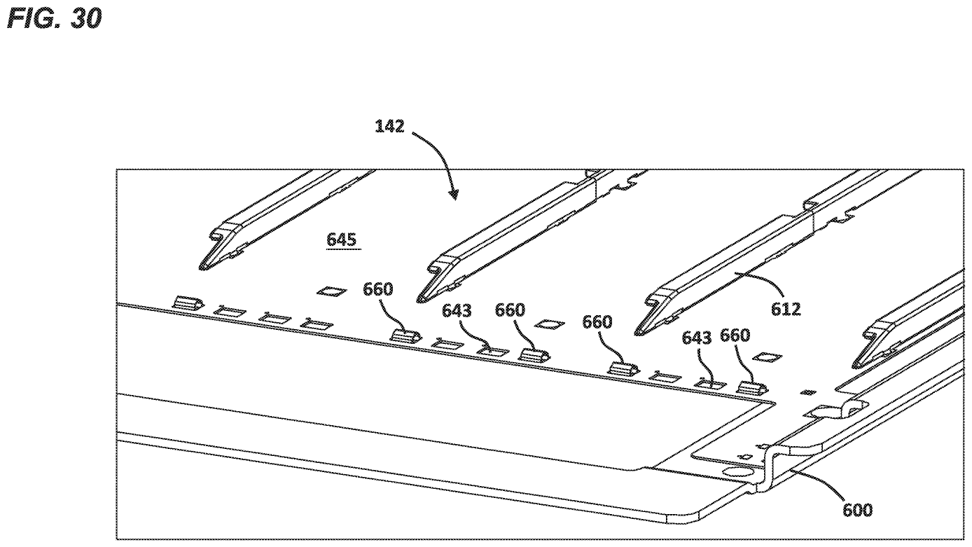

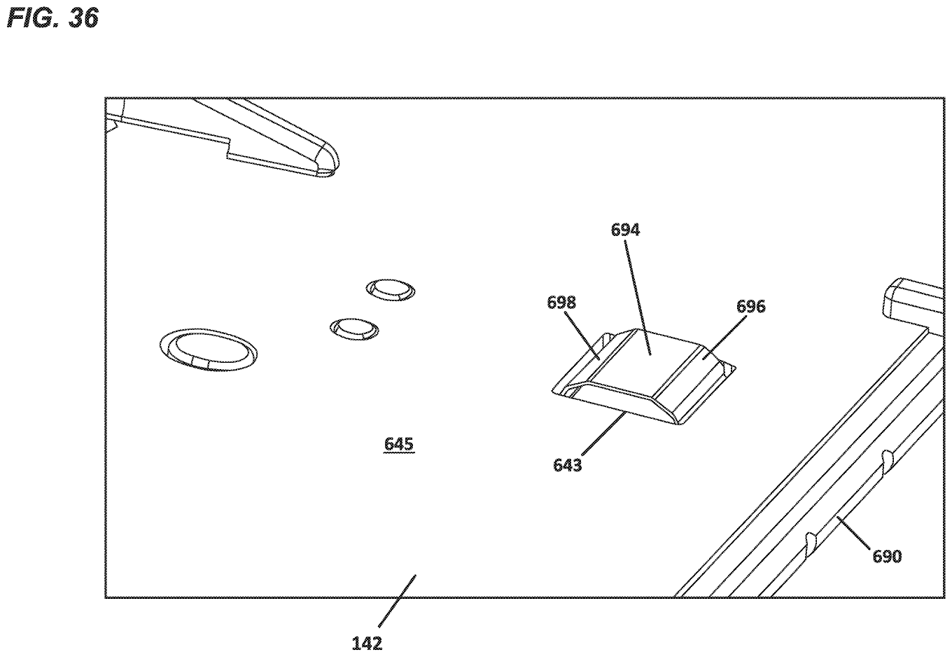

Referring to FIGS. 30 and 36, in certain implementations, the circuit board 142 defines a plurality of windows 643. A respective contact spring 657, 691 can be disposed at one or more of the windows 643. In certain examples, a respective contact spring 657, 691 can be disposed at each bay 614. In certain examples, multiple contact springs 657, 691 can be disposed at each bay 614. In certain examples, the windows 643 are disposed in a row. In certain examples, the windows 643 are disposed in a row at the front 602 of the tray arrangement 600. In certain examples, contact springs 657, 691 can be disposed at the row of windows 643 to detect the plug presence at ports disposed at the front 602 of the tray arrangement 600. In the example shown, the windows 643 are disposed in a first row at the front 602 of the tray arrangement 600 and in a second row at the rear 604 of the tray arrangement 600. In certain examples, contact springs 657, 691 can be disposed at the front and rear rows of windows 643 to detect the plug presence at front ports disposed at the front 602 of the tray arrangement 600 and at rear ports disposed at the rear 604 of the tray arrangement 600.

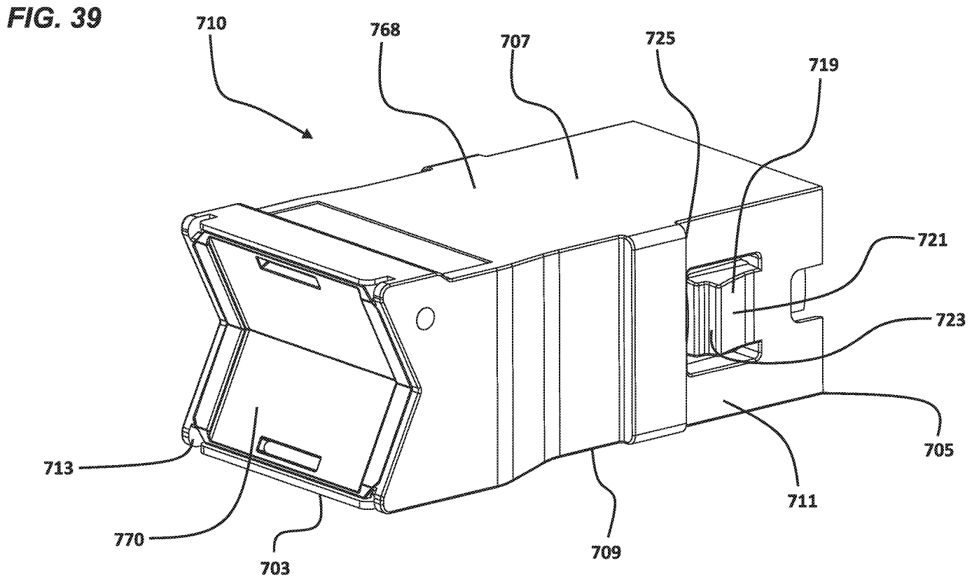

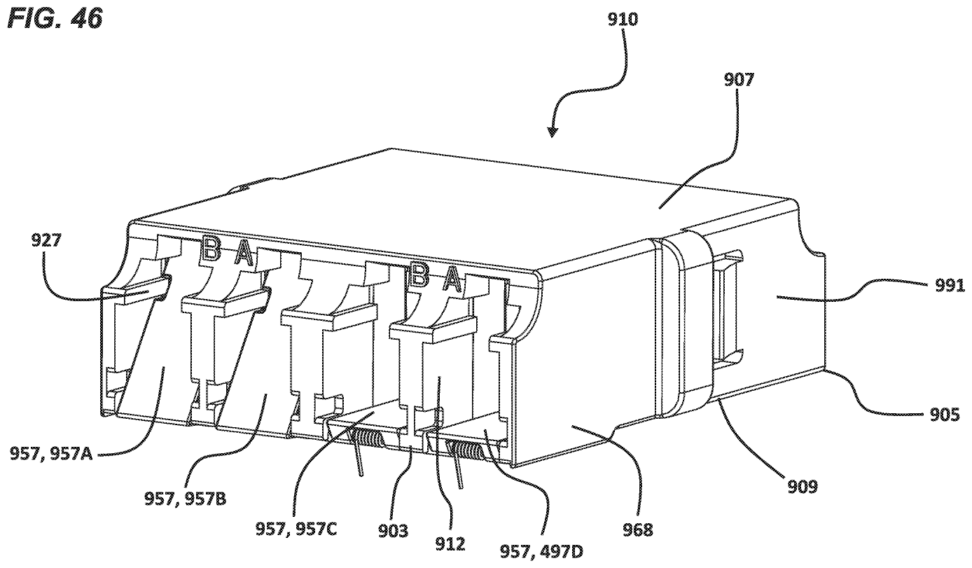

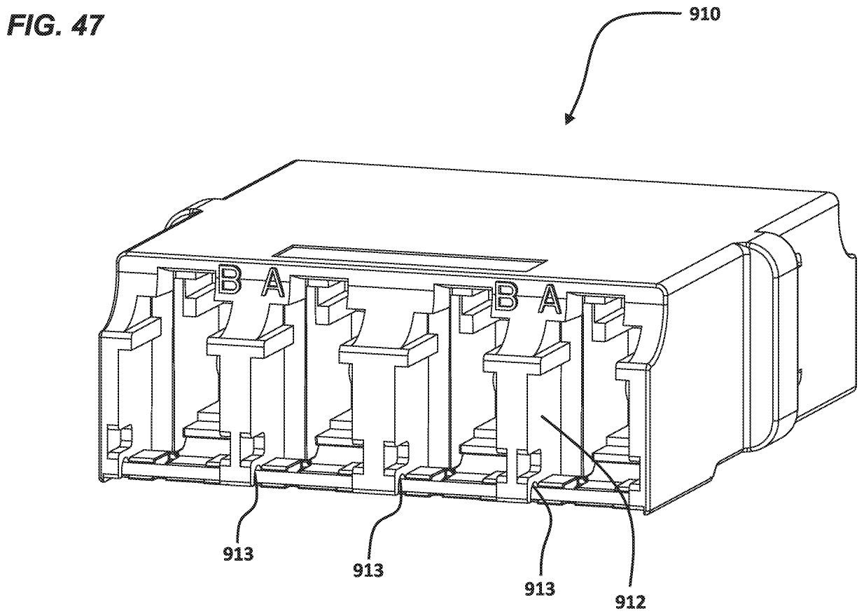

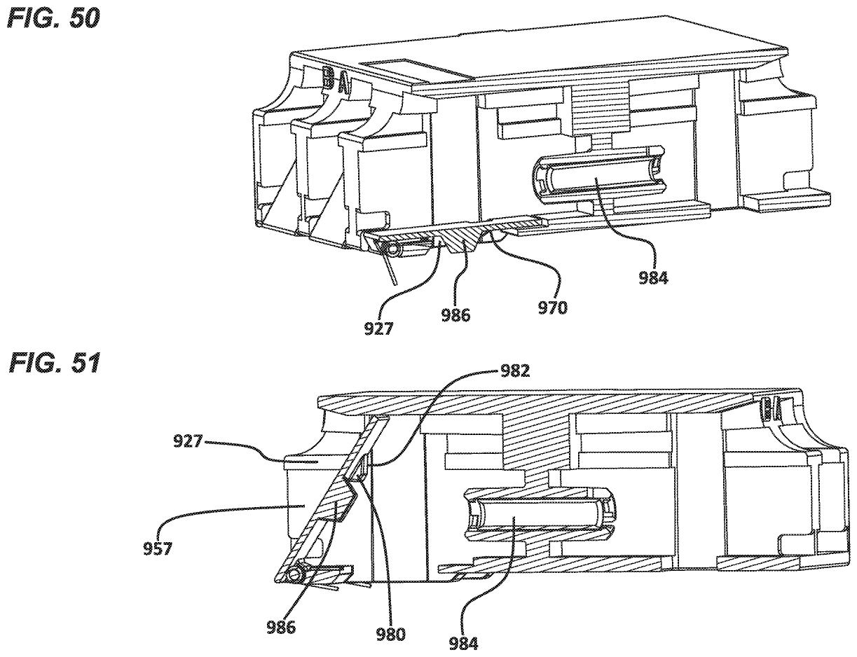

Referring to FIGS. 39-51, various adapters 710, 810, 910 are configured in accordance with the principles of the present disclosure to be selectively positioned at a cassette 110, which can be positioned within one or more bays 614 of a tray arrangement 600. In the example shown in FIGS. 39-42, the adapter 710 is a simplex MPO adapter. In the example shown in FIGS. 43-45, the adapter 810 is a duplex MPO adapter. In the example shown in FIGS. 46-51, the adapter 910 is a quad LC adapter. Other configurations are possible. The adapter 710, 810, 910 can include an adapter body 768, 868, 968 and one or more shutter doors 770, 870, 970. In certain implementations, the one or more shutter doors 770, 870, 970 can be operably coupled to the adapter body 768, 868, 968 via a hinge pin 702, 902. In embodiments, the adapter 710, 810, 910 can include a portion of the port occupancy detection feature (as described in connection with FIGS. 29-38) or a portion that interacts therewith.

The adapter body 768, 868, 968 extends along a depth between a front end 703, 803, 903 and a back end 705, 805, 905. The adapter body 768, 868, 968 also extends along a height between a top portion 707, 807, 907 and a bottom portion 709, 809, 909 and extends along a width between side portions 711, 811, 911. The height, width, and depth are transverse to each other. The adapter body 768, 868, 968 defines one or more forward ports (e.g., a space configured to receive one or more plug connectors) and a corresponding number of rear ports. For example, the adapter body 768 defines one forward port; the adapter body 868 defines two forward ports; and the adapter body 968 defines four forward ports.

As shown in FIGS. 39, 44, and 48, in certain implementations, the adapter body 768, 868, 968 can define a resilient latch member 719, 819, 919 configured to engage a stop surface on the cassette 110. In certain examples, the resilient latch member 719, 819, 919 is configured to be received within a latch window defined by a portion of the cassette 110. In certain examples, the resilient latch member 719, 819, 919 can include a ramp portion 721, 821, 921 and a stop portion 723, 823, 923. When the adapter body 768, 868, 968 is mounted to the cassette 110, a force or pressure exerted upon the ramp portion 721, 821, 921 causes the resilient latch member 719, 819, 919 to deflect inwardly. Upon removal of the force or pressure exerted upon the ramp portion 721, 821, 921, a natural material resiliency of the resilient latch member 719, 819, 919 can cause the resilient latch member 719, 819, 919 to resume its original shape so that stop portion 723, 823, 923 opposes a surface of the cassette 110, thereby inhibiting removal of the adapter body 768, 868, 968 from the cassette 110. In some implementations, the adapter body 768, 868, 968 can further define a second stop portion 725, 825, 925 spaced from and opposed to the first stop portion 723, 823, 923 such that a portion of the cassette 110 can be positioned between the first stop portion 723, 823, 923 and the second stop portion 725, 825, 925, thereby inhibiting movement of the adapter body 768, 868, 968 relative to the cassette 110 in either of the forward or rearward directions.

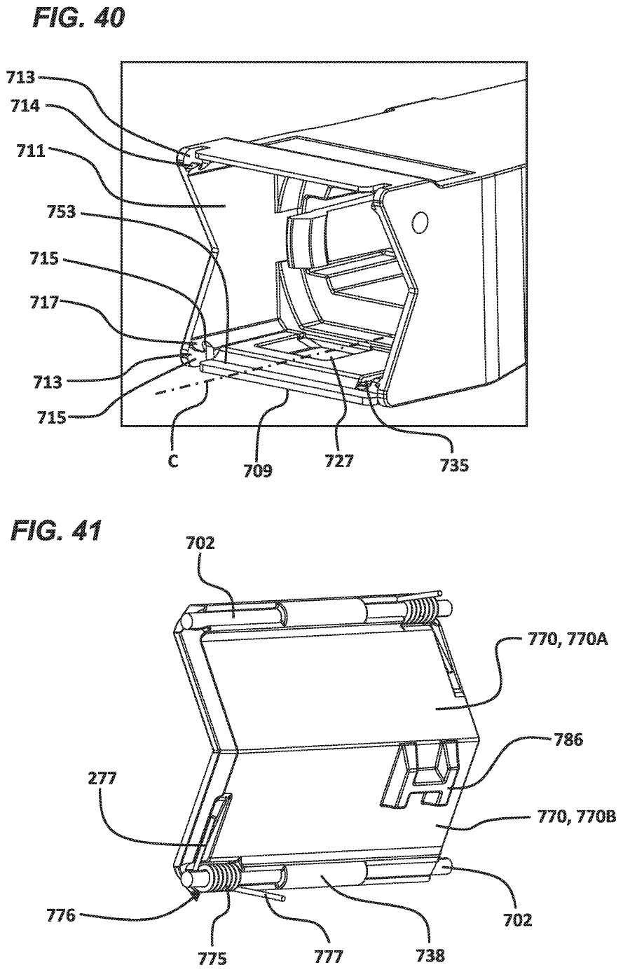

In some implementations, a bottom portion 709, 809, 909 of the adapter body 768, 868, 968 can define one or more port occupancy sensor arrangement windows 727, 827, 927 (as depicted in FIGS. 40, 44, and 48). The one or more windows 727, 827, 927 extend through the bottom portion 709, 809, 909 between an interior of the adapter body 768, 868, 968 and an exterior of the adapter body 768, 868, 968. In certain examples, the one or more port occupancy sensor arrangement window 727, 827, 927 can be horizontally offset from a centerline (C) of the adapter body 768, 868, 968. In some embodiments, the one or more port occupancy sensor arrangement window 727, 827, 927 can be configured to enable a portion of the shutter door 770, 870, 970 to be positioned therein. For example, the actuator 786, 886, 986 of the shutter door 770, 870, 970 can be at least partially positioned within the port occupancy sensor arrangement window 727, 827, 927 when the shutter door 770, 870, 970 is in the open position.

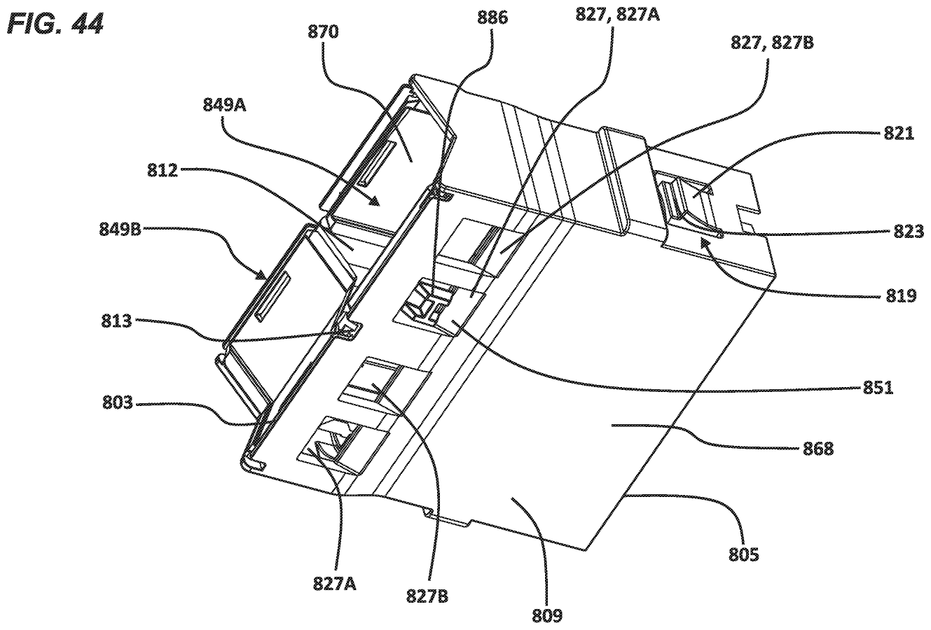

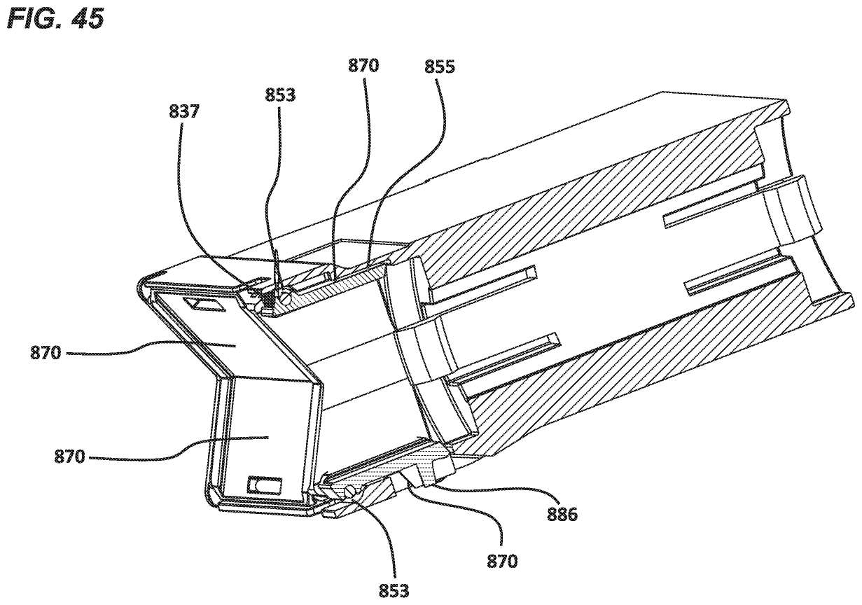

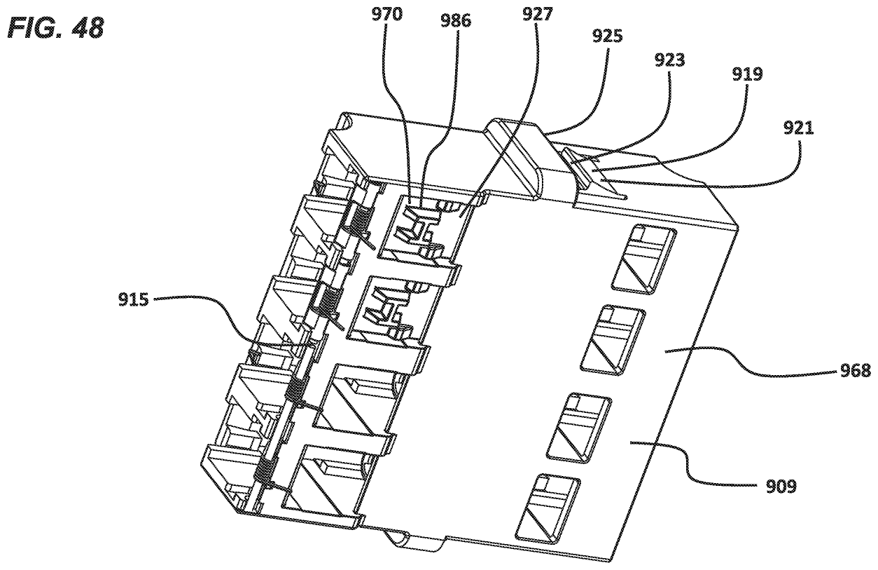

As best depicted in FIGS. 44 and 48, in some embodiments, a bottom portion 809, 909 of the adapter body 868, 968 can define a plurality of port occupancy sensor arrangement windows 827, 927. In certain examples, the spacing of the port occupancy sensor arrangement windows 827, 927 corresponds to the spacing of the ports (e.g., the forward ports ports). In some examples, the corresponding ports are single-fiber ports (e.g., see the ports of adapter 910). In such examples, each window 927 may be configured to receive the actuator 986 of a respective shutter 970 at the corresponding port. In other examples, the corresponding ports are multi-fiber ports (e.g., MPO ports). In such examples, multiple windows 727, 827 may be disposed at each port. A shutter 770, 870 disposed at the port may span the multiple windows 827 while the corresponding actuator 786, 886 may extend into only one of those windows 827. For example, an MPO port tends to have a width roughly twice that of an LC fiber port. Accordingly, as depicted in FIG. 44, a first MPO port 849A and the second MPO port 849B can each define two port occupancy sensor arrangement windows 827A, 827B, with only one port occupancy sensor arrangement window 827A actually being used during port occupancy sensing. Thus, as depicted in FIG. 44, the actuator 886 of the shutter door 870 partially extends through a first port occupancy sensor arrangement window 827A of the MPO port 849A. In the example shown, the second port occupancy sensor window 827B of the MPO port 849A remains vacant even when the respective shutter door 870 is open.

As further depicted in FIGS. 44-45, in examples, the port occupancy sensor arrangement windows 727, 827, 927 of the adapter bodies 768, 868, 928 can be shaped in size to accommodate various forms of port occupancy sensing. For example, in certain implementations, the port occupancy sensor arrangement windows 727, 827 can include a beveled edge 851 conformed to facilitate the contact spring 657, 691 of the port occupancy sensor arrangement positioned on the tray to at least partially protrude into the port occupancy sensor arrangement window 727, 827 (e.g., see FIG. 35). For example, the spring contact may have a ramped or contoured portion that protrudes through the window 727, 827 to be engaged by a plug connector 850 inserted into the port. In certain examples, the ramp or contour of the protruding spring contact portion may match or follow the shape or contour of the beveled edge 851 to account for mounting tolerances of the spring contact. It is noted that while the beveled edge is shown only on the first and second adapter bodies 768 868, the beveled edge also could be used at the window 927 of the fourth adapter body 968.

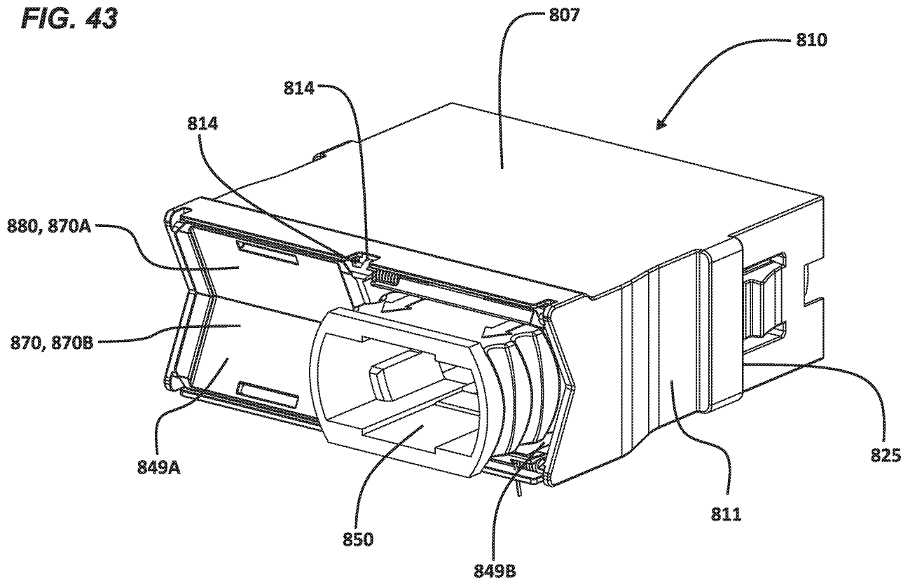

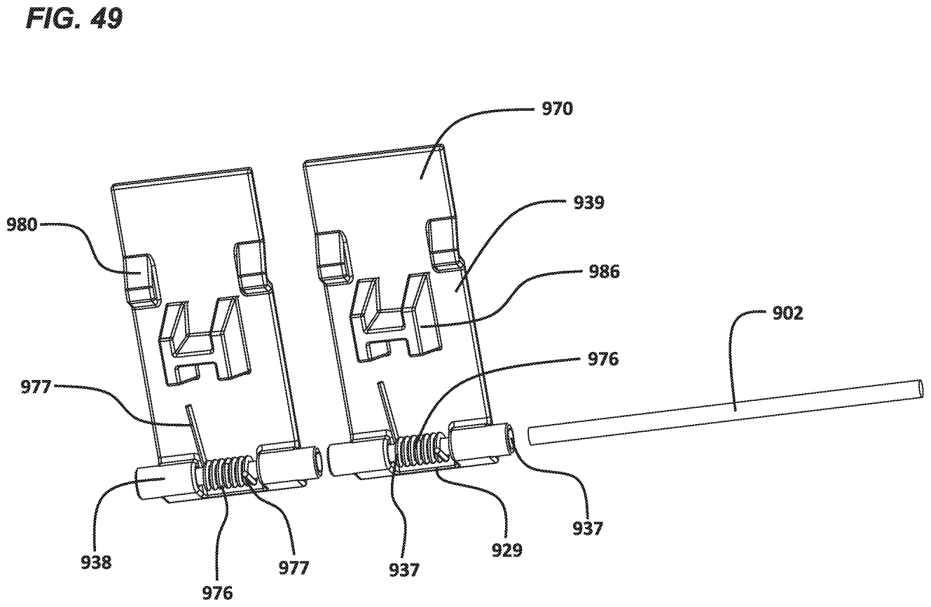

Referring now to FIGS. 42 and 49, in certain implementations, an inside surface 739, 939 of the shutter door 770, 870, 970 can define the actuator 786, 886, 986. In some embodiments, the actuator 786, 886, 986 can be configured to actuate a spring contact resulting in the breaking of an electrical connection between the spring contact and an interfacing surface, thereby indicating that the shutter door 770, 870, 970 is in an open configuration (e.g., which may lead to an inference that the port defined by the adapter body 768, 868, 968 is occupied). In other embodiments, the actuator 786, 886, 986 includes a Hall effect element 750, 950 (e.g., magnetic element or the like) configured to interact with a noncontact sensor (e.g., Hall effect sensor) to indicate a position of the shutter door 770, 870, 970 as being in either of the open configuration or the closed configuration. For example, in some embodiments, the actuator 786, 886, 986 can be carried by a cradle 741, 941, which can include at least one resilient stop 743, 943, which enables the Hall effect element 750, 950 to be inserted into the cradle 741, 941, but inhibits the Hall effect element 750, 950 from being removed from the cradle 741, 941 after insertion.

Each shutter door 770, 870, 970 is configured to pivotally mount at a respective port of the adapter body 768, 868, 968. In certain implementations, a hinge pin 702 extends along a receiving channel 737 of the shutter door 770, 870, 970 to secure the shutter door 770, 870, 970 to the adapter body 768, 868, 968. In certain implementations, a door spring 776, 976 (e.g., a torsion spring) is secured to the shutter door 770, 870, 970 using the hinge pin 702. For example, the hinge pin 702 can extend through a coil of the door spring 776, 976 with a first end 777, 977 of the spring 776, 976 applying a bias against the shutter door 770, 870, 970 and a second end 777, 977 of the spring 776, 976 applying a bias against the adapter body 768, 868, 968.

In certain implementations, the adapter body 768, 868 includes multiple shutter doors 770, 870 disposed at each port receptacle. The shutter doors 770, 870 cooperate to block access to the respective port when the shutter doors 770, 870 are disposed in the closed position. The shutter doors 770, 870 provide access to the respective port when disposed in the open position. In the example shown in FIG. 39-45, a first (e.g., upper) shutter door 770A and a second (e.g., lower) shutter door 770B are disposed within each port receptacle. Each of the shutter doors 770, 870 is pivotably coupled to the adapter body 768, 868 to enable transition between a closed configuration (e.g., such as that depicted in FIG. 39) and an open configuration. In the example shown in FIG. 43, the first MPO port 849A is unoccupied such that the shutter doors 870 are generally in a closed configuration and the second MPO port 849B is occupied by an MPO style plug 850 (an outer portion of which is visible in FIG. 43) such that the shutter doors 870 are generally in an open configuration. The plug 850 is omitted in FIG. 45 for ease in viewing the shutter doors 870.

When in the open configuration, a major surface of the shutter door 770, 870 is substantially parallel with the respective top portion 707, 807 and bottom portion 709, 809 of the adapter body 768, 868. In examples, the MPO adapter 710, 810 can be utilized with the port identification and/or port occupancy detection feature (as described in connection with FIGS. 1-13). In certain examples, only one of the shutter doors 770A of each receptacle carries a presence sensor actuator 786. The port occupancy actuator 786 (or portion of the shutter door 770, 870 holding the same) at least partially protrudes into the respective window 727, 827 when the shutter door 770, 870 is disposed in the open position.

In the closed configuration, the shutter doors 770, 870 can generally be angled inwardly. In certain examples, a hinged connection between the shutter doors 770, 870 and the adapter body 768, 868 is generally positioned at the front end 703, 803 of the cassette body 768, 868 and the pivoting free ends of the shutter doors 770, 870 are generally positioned aft of the front end 703, 803. This configuration of the doors 770, 870 generally reduces the amount of force necessary to transition the shutter doors 770, 870 from the closed configuration to the open configuration to position an MPO plug into the MPO port 849A, 849B.

In certain implementations, each of the shutter doors 770, 870, 970 can define a hinge pin receiving passage 737, 937. The hinge pin 702, 902 seats in the passage 737. In some implementations, the receiving passage 737 defines a groove (e.g., a partial cylindrical impression) extending at least partially along one edge of the shutter door 770, 870. In certain examples, the shutter door 770, 870, 970 can define a spring receiving pocket 729 axially aligned with the channel 737. In some examples, a groove 733 may extend outwardly from the pocket 729 to accommodate one end 777 of the door spring 776. In other examples, the end 977 of the door spring 976 extends over an inner surface of the shutter door 970.

In certain examples, ends 745, 747 of the hinge pin 702 extend axially outwardly from the passage 737 to engage portions of the adapter body 768, 868. For example, the section 738 may be disposed at a central region of the receiving channel 737. Accordingly, in some embodiments, the adapter body 768, 868 can be assembled by positioning the door springs 776 within the torsion spring receptacle 729 defined by each shutter door 770, 870. With the torsion spring 776 in position, the hinge pin 702 can be slid axially into the hinge pin receiving channel 737 and through the body 775 of the torsion spring 776, such that the hinge pin 702 serves to retain the torsion spring 776 within the torsion spring receptacle 729.

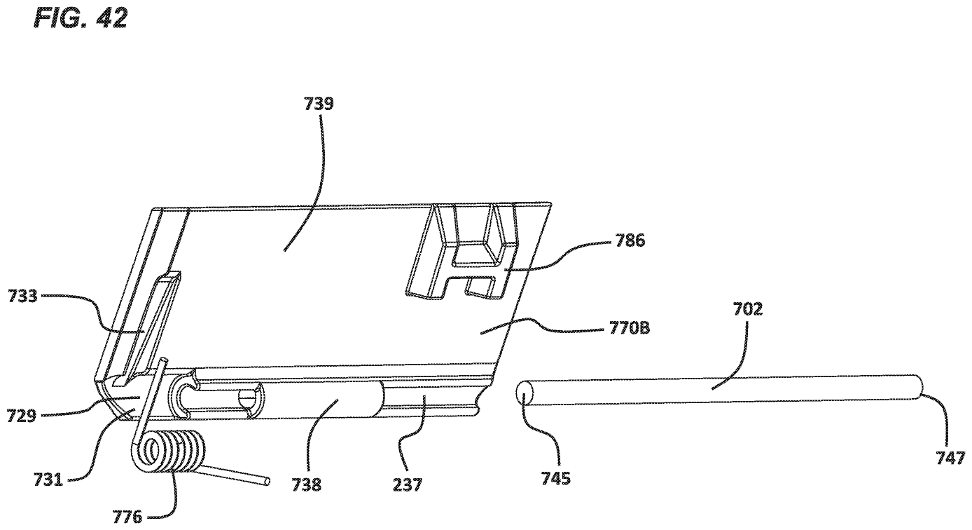

In other implementations, the receiving passage 937 defines a through-passage extending through one or more pivot ends 938 (e.g., cylindrical structures) of the shutter door 970. For example, the shutter door 970 includes two pivot ends 938 protruding outwardly from opposite sides of the shutter door 970 with each pivot end 938 defining a through-passage 937. In the example shown, the door spring 976 is axially aligned with the through-passage between the pivot ends 938. In certain examples, a shutter door 770, 870 can define both a channel and a through-passage along a width of the shutter 770, 870 (e.g., see FIG. 41). In other implementations, no portion of the shutter door 770, 870 completely encircles the hinge pin 702, which can reduce frictional losses between the hinge pin 702 and the shutter door 770, 870 during operation. Further, less material is needed to manufacture such a shutter door 770, 870.

In certain implementations, the adapter body 768, 868, 968 further defines one or more mounting receptacles 713, 813, 913 at which the shutter doors 770, 870, 970 mount to the adapter body 768, 868, 968. In some implementations, the mounting receptacles 713, 813 receive and hold the ends of the hinge pin 702. For example, the ends of a hinge pin 702 can snap-fit into the mounting receptacles 713, 813 (e.g., see FIG. 40). In certain such implementations, the adapter body 768, 868 also defines a groove 753, 853 or other recess to accommodate the pivot end of the shutter door 770, 870 as the door 770, 870 pivots between the open and closed positions.

In certain implementations, one or more of the receptacles 713, 813, 913 may include a stop surface against which an end of the hinge pin 702, 902 can abut to inhibit axial movement of the hinge pin 702, 902 relative to the adapter body 768, 868, 968. In other implementations, one or more of the receptacles 713, 813, 913 may define through-passages through which a hinge pin 702, 902 may extend. In certain implementations, the adapter body 768, 868 includes mounting receptacles 713, 813 at the inner sides of the sidewalls 711, 811 of the adapter body 768, 868. In the examples shown, mounting receptacles 713, 813 913 at the sidewalls 711, 811, 911 include the stop surface (e.g., the inner side of the sidewall 711, 811, 911). In other examples the hinge pin 702, 902 could extend through the sidewalls 711, 811, 911.

In certain examples, the adapter 810 also includes mounting receptacles 813 at one or more dividers 812 between the forward ports. Accordingly, a first hinge pin 702 may extend between a mounting receptacle 813 at a first sidewall 811 of the adapter body 868 and a mounting receptacle 813 at the adjacent divider 812. In some examples, the dividers define a stop surface at the mounting receptacles 813 so that each divider 812 defines two mounting receptacles 813—one on each side. In other examples, the mounting receptacles 813 extend fully through the dividers 812 so that two hinge pins 702 can be received from opposite ends of the same mounting receptacle 813.

Referring to FIG. 40, in some implementations, the mounting receptacle 713, 813 can include a recess 715 configured to retain one end 745, 747 of a hinge pin 702 of a shutter door 770, 870. A resilient retainer 717 also can be positioned at the recess 715 (e.g., see FIG. 40). The retainer 717 is configured to temporarily flex to enable a portion of the hinge pin 702 to be positioned within the recess 715 and then to naturally spring back to its original shape under a natural material resiliency to inhibit removal of the hinge pin 702 from the recess 715. In certain implementations, each hinge pin receptacle 713 includes a ramped surface 714 leading to the recess 715. For example, the ramped surface 714 may lead from an exterior of the adapter body 768, 868. In an example, the ramped surface 714 is wider at the recess 715 than at an opposite end of the ramped surface 714. The shutter door 770, 870 can be pivotably coupled to the adapter body 768, 868 by snapping a respective first end 745 and a second end 747 in the hinge pin receptacles 713 defined by the adapter body 768, 868.

In other implementations, the mounting receptacles 913 receive and engage pivot ends 938 of the shutter door 970 (e.g., see FIG. 48). For example, as shown in FIG. 49, the pivot ends 938 can include hollow cylinders extending outwardly from the shutter door. As discussed above, the pivot ends 938 may define the passage through which the hinge pin 902 extends. In certain implementations, the adapter body 968 defines a channel 915 or other recess extending along a width of the adapter body 968. The channel 915 is accessible from a bottom of the adapter body 968. In certain examples, a gap between the lips or longitudinal edges of the channel 915 is smaller than a cross-dimension (e.g., diameter) of the pivot end 938 of the shutter door 970 so that the pivot end 938 is held within the channel 915 by a natural resiliency of the adapter body 968. In some examples, the adapter body 968 includes a single channel 915 that extends along the width of the adapter body 968 and receives pivot ends of each of the shutter doors 970. In other examples, the adapter body 968 includes multiple channels 915 spaced between the dividers 912 (e.g., see FIG. 48) so that the dividers define stop surfaces between adjacent channels 915.

In certain examples, the shutter doors 970 are coupled via one or more hinge pins 902. In some implementations, each shutter door 970 is secured to the adapter body 968 using a respective hinge pin 902. In other implementations, a single hinge pin 902 can span the width of more than a single shutter door 970 so that multiple shutter doors 970 can be mounted to the same hinge pin 902. Mounting multiple shutter doors 970 to the same hinge pin 902 may facilitate assembly given the small size of the components. For example, the shutter doors 970 can be assembled on the hinge pin 902 external of the adapter body 968 and then mounted within the channel 915 as a unit. In certain examples, the single hinge pin 902 can extend across a majority of a width of the adapter body 968 to engage mounting receptacles 913 at opposite sidewalls 911 of the adapter body 968. In other examples, multiple hinge pins 902 cooperate to extend across a majority of the width of the adapter body 968 with each hinge pin 902 spanning two or more ports.

As further depicted, in some embodiments, each of the shutter doors 970 can include one or more limiters 980 configured to engage with a portion of the adapter body 968 to inhibit over travel of the shutters 812, 852, 882, 902 past the closed position. Each contoured portion 980 defines a pocket 982. For example, as best depicted in FIGS. 21 and 22, certain types of the adapter body 968 can define a limiter 972 (e.g., an inwardly protruding ledge) within the port. When the shutter door 970 is closed, the ledge 972 nests within the pocket 982 defined by the shutter door 970.

### Aspects of the Disclosure

Aspect 1. A communications cassette comprising:
a base extending along a depth between a front and a rear and along a width between opposite first and second sides;
a port member carried by the base, the port member defining a front port; and
a shutter disposed within the front port, the shutter being movable between first and second positions to close and open access to the front port, the shutter carrying a magnet.
Aspect 2. The communications cassette of aspect 1, wherein the shutter door has oppositely facing exterior and interior sides, wherein a mounting arrangement is disposed at the interior side of the shutter, and wherein the magnetic element is held at the mounting arrangement.
Aspect 3. The communications cassette of aspect 2, wherein the mounting arrangement includes two latch arms configured to receive the magnetic element as the magnetic element is pressed towards the interior side of the shutter door.
Aspect 4. The communications cassette of aspect 2, wherein the mounting arrangement includes a cradle and a locking tab, the cradle defining a pocket in which to receive the magnetic element and the locking tab having a shoulder facing the pocket and a ramped surface facing away from the pocket.
Aspect 5. The communications cassette of any of aspects 2-4, wherein the mounting arrangement is disposed along a central longitudinal axis of the shutter.
Aspect 6. The communications cassette of any of aspects 2-4, wherein the mounting arrangement is offset from a central longitudinal axis of the shutter.
Aspect 7. The communications cassette of any of aspects 1-6, wherein the shutter is biased to the first position in which the shutter closes the front port.
Aspect 8. The communications cassette of aspect 7, wherein the shutter is biased to the first position using a torsion spring.
Aspect 9. The communications cassette of any of aspects 1-8, wherein the base defines an aperture extending through a thickness of the base, wherein the magnetic element protrudes into the aperture when the shutter is disposed in the second position.
Aspect 10. The communications cassette of any of aspects 1-15, wherein the port member is a first port member disposed at a front of the base; wherein the shutter is a first shutter; wherein a second port member is carried by the base at the rear of the base, the second port member defining a rear port; and wherein a second shutter is disposed within the rear port, the second shutter being movable between first and second positions to close and open access to the rear port, the second shutter carrying a magnet.
Aspect 11. The communications cassette of any of aspects 1-10, wherein the port member defines a rear port aligned with the front port.
Aspect 12. The communications cassette of any of aspects 1-11, wherein the front port of the port member is one of a plurality of front ports defined by the port member.
Aspect 13. The communications cassette of any of aspects 1-12, wherein the port member is one of a plurality of port members carried by the base.
Aspect 14. The communications cassette of any of aspects 1-13, wherein the base includes a peripheral wall to define an interior.
Aspect 15. The communications cassette of aspect 14, further comprising a cover mounted to the base to close the interior.
Aspect 16. A communications arrangement comprising:
a tray body extending along a depth between a front and a rear, along a width between opposite first and second sides, and along a height between a top and a bottom, the tray body including a plurality of cassettes guides extending along the depth of the tray body;
a circuit board mounted to the tray to form a managed tray, the circuit board having opposite first and second major sides, the second major side of the circuit board facing towards the tray body, the circuit board including a magnetic sensor at the second major side;
a cassette mounted to the managed tray so that the first major side of the circuit board facing towards the cassette, the cassette including a port at which a shutter is disposed, the shutter being movable between a closed position and an open position, the shutter carrying a magnetic element therewith as the shutter moves between the closed and open positions, the shutter configured to move the magnetic element towards the magnetic sensor when the shutter is moved to the open position and to move the magnetic element away from the magnetic sensor when the shutter is moved to the closed position.
Aspect 17. The communications arrangement of aspect 16, wherein the cassette defines an aperture separate from the port, the aperture being aligned with the magnetic sensor and with the magnetic element when the shutter is disposed in the closed position.
Aspect 18. The communications arrangement of aspect 16 or aspect 17, wherein the circuit board extends between the magnetic sensor and the magnetic element regardless of the position of the shutter.
Aspect 19. The communications arrangement of any of aspects 16-18, further comprising a bezel mounted over the second side of the circuit board at the front of the tray body, the bezel covering the magnetic sensor.
Aspect 20. The communications arrangement of any of aspects 16-19, wherein the cassette guides have mounting portions extending through the circuit board to the tray body.
Aspect 21. The communications arrangement of any of aspects 16-20, wherein the magnetic sensor is a Hall element.
Aspect 22. The communications arrangement of any of aspects 16-21, wherein the circuit board includes a portion extending beyond the front of the tray body, and wherein the magnetic sensor is disposed at the portion.
Aspect 23. The communications arrangement of any of aspects 16-22, wherein the magnetic sensor is a first magnetic sensor disposed at the front of the circuit board; and wherein a second magnetic sensor is disposed at the second major side of the circuit board and at the rear of the circuit board.
Aspect 24. The communications arrangement of aspect 23, wherein a second portion of the circuit board extends beyond the rear of the tray body; and wherein the second magnetic sensor is disposed at the second portion.
Aspect 25. A panel system comprising:
a chassis defining an interior;
a tray body mounted to the chassis, the tray body extending between a front and a rear;
a circuit board having opposite first and second major sides, the second major side of the circuit board being mounted to the tray body to form a managed tray, the circuit board including a magnetic sensor at the second major side, the managed tray being configured to receive a cassette; and
a bezel mounted to the managed tray to cover the second side of the portion of the circuit board.
Aspect 26. The panel system of aspect 25, wherein the circuit board includes a portion extending beyond the front of the tray body; and wherein the bezel is disposed forwardly of the front of the tray body.
Aspect 27. The panel system of aspect 25, further comprising a cassette defining a front port, the cassette including a shutter that opens and shuts the front port, the shutter carrying a magnet.
Aspect 28. The communications arrangement of any of aspects 25-27, wherein the magnetic sensor is a Hall element.
Aspect 29. A method of detecting presence of a plug at a communications arrangement including a support structure, a circuit board, and a port member, the support structure carrying the circuit board so that the circuit board is disposed between the support structure and at least a portion of the port member, the method comprising:
inserting a plug into a front port of the port member;
opening a shutter of the port member by insertion of the plug and thereby moving a magnetic element from a first position to a second position; and
inserting the magnetic element protruding into an aperture that is defined by the port member and leads towards the circuit board, wherein the magnetic element is moved into and out of proximity with a magnetic sensor as the shutter is moved.
Aspect 30. The method of claim 29, wherein disposing the magnetic element at the aperture brings the magnetic element into operational range to a magnetic sensor mounted to the circuit board.
Aspect 31. The method of claim 29, wherein disposing the magnetic element at the aperture brings the magnetic element out of operational range of the magnetic sensor mounted to the circuit board.
Aspect 32. The communications arrangement of any of aspects 29-32, wherein the magnetic sensor is a Hall element.
Aspect 33. The communications arrangement of aspects 29-32, wherein the support structure includes a tray.
Aspect 34. An optical adapter assembly comprising:
an adapter body extending along a depth between a front end and a rear end, along a height between a top portion and a bottom portion, and along a width between opposite sidewalls, the adapter body defining aligned front and rear ports, the bottom portion defining at least one port occupancy sensor arrangement window aligned with the front port, the adapter body defining a mounting receptacle;
a port shutter mounted to the adapter body at the front port using the mounting receptacle, the port shutter being pivotally movable between closed and open positions, the port shutter also including an actuator cradle monolithically formed with the door;
an actuator mounted at the actuator cradle;
a door spring mounted to the port shutter to bias the port shutter to the closed position, the door blocking the front port when the port shutter is disposed in the closed position, the door spring being different from the actuator.
Aspect 35. The optical adapter assembly of aspect 34, wherein the door spring is a torsion spring.
Aspect 36. The optical adapter assembly of aspect 34, further comprising a hinge pin coupled to the shutter door, the hinge pin having an end abutting an inner surface of one of the sidewalls of the adapter body, the port shutter pivotally movable about the hinge pin between the closed and open positions.
Aspect 37. The optical adapter assembly of aspect 36, wherein the door of the port shutter defines a hinge pin receiving channel along which the hinge pin extends, and wherein the hinge pin extends through the door spring to hold the door spring to the port shutter.
Aspect 38. The optical adapter assembly of aspect 37, wherein the door of the port shutter has a potion that fully encircles the hinge pin.
Aspect 39. The optical adapter assembly of aspect 37 or aspect 38, wherein the door of the port shutter defines a groove extending outwardly from the hinge pin receiving channel.
Aspect 40. The optical adapter assembly of aspect 36, wherein the door of the port shutter defines pivot ends defining through passages therethrough, the hinge pin extending along the through passages, and the door spring being disposed between the pivot ends.
Aspect 41. The optical adapter assembly of aspect 36, wherein the front port of the adapter body is one of a plurality of front ports and wherein the port shutter is one of a plurality of port shutters, each port shutter being disposed at a respective one of the front ports.
Aspect 42. The optical adapter assembly of aspect 41, wherein each of the port shutters is coupled to the hinge pin.
Aspect 43. The optical adapter assembly of aspect 41, wherein the hinge pin is one of a plurality of hinge pins that cooperate to span the width of the adapter, each hinge pin being coupled to at least one of the port shutters.
Aspect 44. The optical adapter assembly of aspect 41, wherein the adapter body defines a plurality of port occupancy sensor arrangement windows, each port occupancy sensor arrangement window being aligned with a respective one of the front ports.
Aspect 45. The optical adapter assembly of aspect 44, wherein multiple ones of the port occupancy sensor arrangement windows are disposed at a common one of the front ports.
Aspect 46. The optical adapter assembly of aspect 45, wherein the actuator aligns with only one of the port occupancy sensor arrangement windows disposed at the common one of the front ports.
Aspect 47. The optical adapter assembly of aspect 36, wherein the mounting receptacle defines a recess sized to receive the end of the hinge pin.
Aspect 48. The optical adapter assembly of aspect 47, wherein the mounting receptacle defines a ramp leading to the recess.
Aspect 49. The optical adapter assembly of aspect 47 or aspect 48, wherein a resilient retainer holds the end of the hinge pin within the recess.
Aspect 50. The optical adapter assembly of any of aspects 34-49, wherein the at least one port occupancy sensor arrangement window has a beveled edge leading between an interior of the adapter body and an exterior of the adapter body.
Aspect 51. The optical adapter assembly of aspect 34, wherein the door of the port shutter includes pivot ends that snap into the mounting receptacle and pivot within the mounting receptacle.
Aspect 52. The optical adapter assembly of aspect 51, wherein the mounting receptacle extends along the width of the adapter body and defines an opening accessible from a bottom of the adapter body through a gap.
Aspect 53. The optical adapter assembly of aspect 52, wherein the gap is smaller than a cross-dimension of the hinge pin at least where the pivot ends of the port shutter are disposed.
Aspect 54. The optical adapter assembly of aspects 34-53, wherein the adapter body is mounted to a cassette.
Aspect 55. The optical adapter assembly of aspect 54, wherein the cassette is mounted to a tray carrying a circuit board having a first portion of a port occupancy sensor arrangement, wherein the port occupancy sensor arrangement window aligns with the first portion of the port occupancy sensor arrangement.
Aspect 56. The optical adapter assembly of aspect 55, wherein the first portion of the port occupancy sensor arrangement includes a Hall Effect sensor.
Aspect 57. The optical adapter assembly of aspect 56, wherein the actuator includes magnetic element configured to influence the Hall Effect sensor when the port shutter is open and to not influence the Hall Effect sensor when the port shutter is closed.
Aspect 58. A panel system comprising:
a chassis defining an interior;
a tray mounted to the chassis, the tray extending between a front and a rear, the tray being configured to receive a cassette;
a circuit board carried by the tray, the circuit board having opposite first and second major sides, the second major side of the circuit board facing towards the tray, the circuit board including a contact interface disposed at the second major side, circuit board defining a window extending between the first and second major sides of the circuit board;
a contact spring mounted to the circuit board in a cantilever position so that a free end of the contact spring is deflectable away from the circuit board from a first position, the contact spring defining a protrusion that aligns with the window so that the protrusion extends through the window from the second major side of the circuit board towards the first major side of the circuit board, the contact spring also defining a contact surface that aligns with and contacts the contact interface when in the first position.
Aspect 59. The panel system of aspect 58, wherein the protrusion is formed by a bent portion of the contact spring.
Aspect 60. The panel system of any of aspects 58-59, wherein the protrusion defines a forward-facing cam surface and a rearward-facing cam surface.
Aspect 61. The panel system of any of aspects 58-60, wherein the protrusion is disposed between a mounting location of the contact spring and the contact surface.
Aspect 62. The panel system of any of aspects 58-60, wherein the contact surface is disposed between a mounting location of the contact spring and the protrusion.
Aspect 63. The panel system of any of aspects 58-62, wherein the contact spring extends from a fixed end mounted to the circuit board to the free end.
Aspect 64. The panel system of any of aspects 58-62, wherein the contact surface is a first contact surface, wherein the contact spring includes a second contact surface spaced along a length of the contact spring from the first contact surface, and wherein the contact spring is mounted to the circuit board at a location intermediate the first and second contact surfaces.
Aspect 65. The panel system of any of claims 58-64, wherein the contact spring defines a flat actuation surface.
Aspect 66. The panel system of any of aspects 58-64, wherein the contact spring defines a contoured actuation surface.
Aspect 67. The panel system of any of aspects 58-66, wherein the circuit board includes a portion extending beyond the front of the tray.
Aspect 68. The panel system of aspect 67, further comprising a bezel that mounts to the tray, the bezel extending along the portion of the circuit board forward of the tray so that at least a portion of the contact spring is disposed between the bezel and the circuit board.
Aspect 69. The panel system of any of aspects 58-68, wherein the protrusion of the contact spring is configured to extend through the window beyond the first major side of the circuit board when in the first position.
Aspect 70. The panel system of any of aspects 58-69, further comprising a cassette mounted to the tray, the cassette carrying a port member defining a front port, the port member including a shutter door disposed at the front port, the shutter door being movable between open and closed positions, the shutter door including an actuation surface that contacts and depresses the protrusion of the contact spring when the shutter door is disposed in the open position, wherein the actuation surface is spaced from the contact spring when the shutter door is disposed in the closed position.
Aspect 71. The panel system of aspect 70, wherein the contact surface of the contact spring is moved away from the contact interface when the actuation surface depresses the protrusion of the contact spring.
Aspect 72. The panel system of aspect 70, wherein the actuation surface includes an inward protrusion carried by the shutter door.
Aspect 73. The panel system of any of aspects 70-72, wherein the shutter door is biased to the closed position.
Aspect 74. The panel system of any of aspects 58-73, wherein the shutter door is biased to the closed position by a torsion spring that is separate from the contact spring.
Aspect 75. The panel system of any of aspects 58-74, wherein the tray is movable relative to the chassis between retracted and extended positions.
Aspect 76. A communications arrangement comprising:
a tray extending along a depth between a front and a rear, along a width between opposite first and second sides, and along a height between a top and a bottom, the tray including a plurality of cassettes guides extending along the depth of the tray;
a circuit board disposed at the top of the tray, the circuit board having opposite first and second major sides, the second major side of the circuit board facing the top of the tray, the circuit board including a contact interface disposed at the second major side, the circuit board defining a window extending between the first and second major sides of the circuit board; and
a contact spring disposed at the second major side of the circuit board, the contact spring defining a protrusion that aligns with the window so that the protrusion extends through the window when the contact spring is disposed in a first position, the contact spring also defining a contact surface that contacts a contact interface at the second side of the circuit board when the contact spring is disposed in the first position, the contact surface being movable away from the contact interface.
Aspect 77. The communications arrangement of aspect 76, further comprising a cassette mounted to the tray using at least two of the cassette guides, the cassette carrying a port member that defines an aperture extending between an exterior of the port member and an interior of the port member, the aperture at least partially overlapping with the window defined by the circuit board when the cassette is mounted to the tray.
Aspect 78. The communications arrangement of aspect 76 or aspect 77, wherein the contact surface of the contact spring is disposed between a mounting location of the contact spring and the protrusion of the contact spring.
Aspect 79. The communications arrangement of aspect 76 or aspect 77, wherein the protrusion of the contact spring is disposed between a mounting location of the contact spring and the contact surface of the contact spring.
Aspect 80. The communications arrangement of any of aspects 76-79, wherein the contact spring includes a deflectable metal spring coupled to a plastic base, and wherein the plastic base is mounted to the second major side of the circuit board.
Aspect 81. The communications arrangement of any of aspects 76-80, wherein the circuit board includes a portion extending beyond the front of the tray, wherein the contact spring is mounted to the second side of the portion of the circuit board.

Aspect 82. A method of detecting presence of a plug at a communications arrangement including a circuit board and a port member, the circuit board including a magnetic sensor, the method comprising:
inserting a plug into a front port of the port member; and
opening a shutter of the port member by insertion of the plug and thereby moving a magnetic element from a first position to a second position, wherein at least a portion of the magnetic element is disposed within an aperture that is defined by the port member when the magnetic element is disposed in the second position.
Aspect 83. The method of aspect 82, wherein the magnetic sensor is disposed relative to the port member so that the magnetic element is within operational range of the magnetic sensor when disposed in the second position and not within operational range when disposed in the first position.
Aspect 84. The method of aspect 83, wherein the circuit board is mounted between the port member and a support structure.
Aspect 85. the method of aspect 84, wherein the support structure includes a tray.
Aspect 86. The method of aspect 82, wherein the magnetic sensor is disposed relative to the port member so that the magnetic element is within operational range of the magnetic sensor when disposed in the first position and not within operational range when disposed in the second position.
Aspect 87. The method of aspect 86, wherein the port member is mounted between the circuit board and a support structure.
Aspect 88. The method of aspect 87, wherein the support structure includes a bulkhead frame.
Aspect 89. An optical adapter assembly comprising:
an adapter body extending along a depth between a front end and a rear end, along a height between a top portion and a bottom portion, and along a width between opposite sidewalls, the adapter body defining aligned front and rear ports, the bottom portion defining at least one port occupancy sensor arrangement window aligned with the front port, the adapter body defining a mounting receptacle;
a port shutter mounted to the adapter body at the front port using the mounting receptacle, the port shutter being pivotally movable between closed and open positions, the port shutter also including an actuator monolithically formed with the door;
a door spring mounted to the port shutter to bias the port shutter to the closed position, the door blocking the front port when the port shutter is disposed in the closed position, the door spring being different from the actuator or actuator cradle.
Aspect 90. The optical adapter assembly of aspect 89, wherein the door spring is a torsion spring.
Aspect 91. The optical adapter assembly of aspect 89, further comprising a hinge pin coupled to the shutter door, the hinge pin having an end abutting an inner surface of one of the sidewalls of the adapter body, the port shutter pivotally movable about the hinge pin between the closed and open positions.
Aspect 91. The optical adapter assembly of aspect 91, wherein the door of the port shutter defines a hinge pin receiving channel along which the hinge pin extends, and wherein the hinge pin extends through the door spring to hold the door spring to the port shutter.
Aspect 92. The optical adapter assembly of aspect 92, wherein the door of the port shutter has a potion that fully encircles the hinge pin.
Aspect 93. The optical adapter assembly of aspect 91 or aspect 92, wherein the door of the port shutter defines a groove extending outwardly from the hinge pin receiving channel.
Aspect 94. The optical adapter assembly of aspect 90, wherein the door of the port shutter defines pivot ends defining through passages therethrough, the hinge pin extending along the through passages, and the door spring being disposed between the pivot ends.
Aspect 95. The optical adapter assembly of aspect 90, wherein the front port of the adapter body is one of a plurality of front ports and wherein the port shutter is one of a plurality of port shutters, each port shutter being disposed at a respective one of the front ports.
Aspect 96. The optical adapter assembly of aspect 95, wherein each of the port shutters is coupled to the hinge pin.
Aspect 97. The optical adapter assembly of aspect 95, wherein the hinge pin is one of a plurality of hinge pins that cooperate to span the width of the adapter, each hinge pin being coupled to at least one of the port shutters.
Aspect 98. The optical adapter assembly of aspect 95, wherein the adapter body defines a plurality of port occupancy sensor arrangement windows, each port occupancy sensor arrangement window being aligned with a respective one of the front ports.
Aspect 99. The optical adapter assembly of aspect 98, wherein multiple ones of the port occupancy sensor arrangement windows are disposed at a common one of the front ports.
Aspect 100. The optical adapter assembly of aspect 99, wherein the actuator aligns with only one of the port occupancy sensor arrangement windows disposed at the common one of the front ports.
Aspect 101. The optical adapter assembly of aspect 90, wherein the mounting receptacle defines a recess sized to receive the end of the hinge pin.
Aspect 102. The optical adapter assembly of aspect 101, wherein the mounting receptacle defines a ramp leading to the recess.
Aspect 103. The optical adapter assembly of aspect 101 or aspect 102, wherein a resilient retainer holds the end of the hinge pin within the recess.
Aspect 104. The optical adapter assembly of any of aspects 89-103, wherein the at least one port occupancy sensor arrangement window has a beveled edge leading between an interior of the adapter body and an exterior of the adapter body.
Aspect 105. The optical adapter assembly of aspect 89, wherein the door of the port shutter includes pivot ends that snap into the mounting receptacle and pivot within the mounting receptacle.
Aspect 106. The optical adapter assembly of aspect 105, wherein the mounting receptacle extends along the width of the adapter body and defines an opening accessible from a bottom of the adapter body through a gap.
Aspect 107. The optical adapter assembly of aspect 106, wherein the gap is smaller than a cross-dimension of the hinge pin at least where the pivot ends of the port shutter are disposed.
Aspect 108. The optical adapter assembly of aspects 89-107, wherein the adapter body is mounted to a cassette.
Aspect 109. The optical adapter assembly of aspect 108, wherein the cassette is mounted to a tray carrying a circuit board having a first portion of a port occupancy sensor arrangement, wherein the port occupancy sensor arrangement window aligns with the first portion of the port occupancy sensor arrangement.
Aspect 110. The optical adapter assembly of aspect 109, wherein the first portion of the port occupancy sensor arrangement includes a contact spring flexible between first and second positions, the contact spring partially protruding through the port occupancy sensor arrangement window when in the first position.
Aspect 111. The optical adapter assembly of aspect 110, wherein a protruding portion of the contact spring engages the actuator when the port shutter is disposed in the open position.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A communications cassette comprising:
a base extending along a depth between a front and a rear and along a width between opposite first and second sides;
a port member carried by the base, the port member defining a front port and defining an aperture extending at an angle relative to the front port; and
a shutter door disposed at the front port, the shutter door being movable between first and second positions to close and open access to the front port, respectively, the shutter door carrying a protruding structure that extends at least partially through the aperture when the shutter door is disposed in the second position.

2. The communications cassette of claim 1, wherein the protruding structure forms part of a mounting arrangement that carries a magnetic element.

3. The communications cassette of claim 2, wherein the shutter door has oppositely facing exterior and interior sides, wherein the mounting arrangement is disposed at the interior side of the shutter door.

4. The communications cassette of claim 2, wherein the mounting arrangement includes two latch arms configured to receive the magnetic element as the magnetic element is pressed towards the interior side of the shutter door.

5. The communications cassette of claim 2, wherein the mounting arrangement includes a cradle and a locking tab, the cradle defining a pocket in which to receive the magnetic element and the locking tab having a shoulder facing the pocket and a ramped surface facing away from the pocket.

6. The communications cassette of claim 2, wherein the mounting arrangement is disposed along a central longitudinal axis of the shutter door.

7. The communications cassette of claim 2, wherein the mounting arrangement is offset from a central longitudinal axis of the shutter door.

8. The communications cassette of claim 1, wherein the shutter door is biased to the first position in which the shutter door closes the front port.

9. The communications cassette of claim 8, wherein the shutter door is biased to the first position using a torsion spring.

10. The communications cassette of claim 1, wherein the port member is a first port member disposed at a front of the base; wherein the shutter door is a first shutter door; wherein a second port member is carried by the base at the rear of the base, the second port member defining a rear port; and wherein a second shutter door is disposed within the rear port, the second shutter door being movable between first and second positions to close and open access to the rear port, the second shutter door carrying a magnet.

11. The communications cassette of claim 1, wherein the port member defines a rear port aligned with the front port.

12. The communications cassette of claim 1, wherein the front port of the port member is one of a plurality of front ports defined by the port member.

13. The communications cassette of claim 1, wherein the port member is one of a plurality of port members carried by the base, each port member of the plurality of port members defining a respective front port.

14. The communications cassette of claim 1, wherein the protruding structure has an H-shape.

15. A communications arrangement comprising:
a tray body extending along a depth between a front and a rear, along a width between opposite first and second sides, and along a height between a top and a bottom, the tray body including a plurality of cassettes guides extending along the depth of the tray body;
a circuit board mounted to the tray to form a managed tray, the circuit board having opposite first and second major sides, the second major side of the circuit board facing towards the tray body, the circuit board including a first portion of a port occupancy sensor arrangement disposed at the second major side;
a cassette mounted to the managed tray so that the first major side of the circuit board faces towards the cassette, the cassette including a front port at which a shutter is disposed, the shutter being movable between a closed position and an open position, the shutter including a second portion of the port occupancy sensor arrangement that moves therewith as the shutter moves between the closed and open positions, the shutter configured to move the second portion of the port occupancy sensor arrangement towards the first portion of the port occupancy sensor arrangement when the shutter is moved to the open position and to move the second portion of the port occupancy sensor arrangement away from the first portion of the port occupancy sensor arrangement when the shutter is moved to the closed position.

16. The communications arrangement of claim 15, wherein the first portion of the port occupancy sensor arrangement includes a magnetic sensor and the second portion of the port occupancy sensor arrangement includes a magnetic element.

17. The communications arrangement of claim 16, wherein the magnetic sensor includes a Hall Effect sensor; and wherein the magnetic element includes a magnet carried by a mounting structure extending inwardly from the shutter.

18. The communications arrangement of claim 15, wherein the first portion of the port occupancy sensor arrangement includes a landing pad and cantilevered spring and the second portion of the port occupancy sensor arrangement includes a protruding actuator.

19. The communications arrangement of claim 15, wherein the front port of the cassette is formed by a port member carried by a body of the cassette, wherein the port member defines an aperture separate from the front port, the aperture being aligned with the first portion of the port occupancy sensor and with the first portion of the port occupancy sensor when the shutter is disposed in the closed position.

20. The communications arrangement of claim 15, wherein the circuit board extends between the first portion of the port occupancy sensor and the second portion of the port occupancy sensor regardless of the position of the shutter.

21. The communications arrangement of claim 15, further comprising a bezel mounted over the second side of the circuit board at the front of the tray body, the bezel covering the first portion of the port occupancy sensor arrangement.

22. The communications arrangement of claim 15, wherein the cassette guides have mounting portions extending through the circuit board to the tray body.

23. The communications arrangement of claim 16, wherein the magnetic sensor is a first magnetic sensor disposed at the front of the circuit board; and wherein a second magnetic sensor is disposed at the second major side of the circuit board and at the rear of the circuit board.

24. The communications arrangement of claim 23, wherein a second portion of the circuit board extends beyond the rear of the tray body; and wherein the second magnetic sensor is disposed at the second portion.

25. A panel system comprising:
a chassis defining an interior;
a tray body mounted to the chassis, the tray body extending between a front and a rear;
a circuit board having opposite first and second major sides, the second major side of the circuit board being mounted to the tray body to form a managed tray, the circuit board including a magnetic sensor at the second major side, the managed tray being configured to receive a cassette; and
a bezel mounted to the managed tray to cover the second side of the portion of the circuit board.

26. The panel system of claim 25, wherein the circuit board includes a portion extending beyond the front of the tray body; and wherein the bezel is disposed forwardly of the front of the tray body.

27. The panel system of claim 25, further comprising a cassette defining a front port, the cassette including a shutter that opens and shuts the front port, the shutter carrying a magnet.

28. The communications arrangement of claim 25, wherein the magnetic sensor is a Hall element.

29. A method of detecting presence of a plug at a communications arrangement including a circuit board and a port member, the circuit board including a magnetic sensor, the method comprising:
inserting a plug into a front port of the port member; and
opening a shutter of the port member by insertion of the plug and thereby moving a magnetic element from a first position to a second position, wherein at least a portion of the magnetic element is disposed within an aperture that is defined by the port member when the magnetic element is disposed in the second position.

30. The method of claim 29, wherein the magnetic sensor is disposed relative to the port member so that the magnetic element is within operational range of the magnetic sensor when disposed in the second position and not within operational range when disposed in the first position.

31. The method of claim 30, wherein the circuit board is mounted between the port member and a support structure.

32. The method of claim 31, wherein the support structure includes a tray.

33. The method of claim 29, wherein the magnetic sensor is disposed relative to the port member so that the magnetic element is within operational range of the magnetic sensor when disposed in the first position and not within operational range when disposed in the second position.

34. The method of claim 33, wherein the port member is mounted between the circuit board and a support structure.

35. The method of claim 34, wherein the support structure includes a bulkhead frame.
